(19) United States
(12) Patent Application Publication
(10) Pub. No.: US 2011/0101215 A1
(43) Pub. Date: May 5, 2011

(54) QUANTITATIVE ANALYSIS METHOD USING MASS SPECTROMETER

(76) Inventors: Atsumu Hirabayashi, Kodaira (JP); Masako Ishimaru, Tokyo (JP); Kiyomi Yoshinari, Hitachi (JP); Naomi Manri, Kawagoe (JP)

(21) Appl. No.: 12/921,087

(22) PCT Filed: Mar. 27, 2009
(86) PCT No.: PCT/JP2009/056915

§ 371 Date: Dec. 10, 2010

(30) Foreign Application Priority Data
Apr. 3, 2008 (JP) 2008-096710 2008

(51) Int. Cl. H01J 49/00

(52) U.S. Cl. 250/282; 250/281

(57) ABSTRACT

In quantitation without using the isotope labeling technique, there is no means to detect the presence/absence and the time region of the occurrence of quantitative analysis-inhibitory factors in data for the analysis, and the reliability of the data for the analysis cannot be evaluated. Also, the error of the data due to the occurrence of the quantitative analysis-inhibitory factors cannot be evaluated. In order to solve the problems, first, an internal standard to be detected simultaneously with a component for the analysis is mixed in a mobile phase or an eluate of a liquid chromatograph; under the condition where no quantitative analysis-inhibitory factors occur, a blank sample is analyzed to acquire a mass chromatogram of ions originated from the internal standard; and the result is stored in a data storage unit. Then, a sample for the analysis is mixed to acquire data for the analysis of the sample; and the intensity of ions originated from the internal standard is compared with that of the blank sample in the analysis real time in a data analysis unit. At this time, if an inconsistency exceeding a predetermined threshold is detected, the occurrence of the quantitative analysis-inhibitory factors can be detected. Further, based on the inconsistency, the error range of the data can be given to a data set and the like.

### TECHNICAL FIELD

The present invention relates to a mass spectrometry system for organism-related substances and organic substances, and the like, and particularly to a quantitative mass spectrometry and a mass spectrometry system for pharmacokinetics and drug metabolism in drug discovery, protein analyses, and searches for clinical markers. The present invention relates further to an automatic tester and an automatic analyzer to analyze body fluids and the like.

### BACKGROUND ART

In marker searches and the like for disease diagnoses, it is important that analysis results of samples originated from disease subjects and samples originated from healthy subjects be compared and that variant components exhibiting outstanding differences be extracted from among detected components. Additionally, it is also necessary that the variant components be identified. In such analyses, liquid chromatograph/mass spectrometers (LC/MS) are often used. The LC/MS is an on-line system capable of separating a sample containing multiple components by LC and analyzing the masses of separated components by MS, and so it is used broadly also in the fields other than marker searches. For the mass spectrometer (MS) unit, a mass spectrometer having a high mass resolving power and securing three or more digits in the dynamic range is often used which can perform the tandem mass spectrometry such as MS/MS analysis. Thereby, a series of analyses can precisely be performed which includes the extraction of variant components by the quantitation, the identification (qualitative analysis) of a large number of unknown components in variant components, and the measurement of the contents thereof by the quantitative analysis.

As well known, the tandem mass spectrometry is a technology in which ions of a component are selected from a result of a mass spectrometry, and made to impact against a gas molecule, or otherwise, to be decomposed, and ions produced by the decomposition are further subjected to a mass spectrometry; and the tandem mass spectrometry is generally performed for the identification (qualitative analysis) of a substance. On the other hand, in the quantitative analysis, a mass spectrum is acquired without using the tandem mass spectrometry in many cases. If an ion of a substance is given attention to, and subjected to a qualitative analysis by the tandem mass spectrometry, data by the mass spectrometry without using the tandem cannot be acquired during that time, resulting in exhibiting a relation of substantially decreasing the precision of the quantitative analysis. Hence, when a quantitative analysis is performed, a control not to perform the tandem spectrometry is needed. Therefore, conventionally, a qualitative analysis in which a tandem mass spectrometry is first performed for the identification is performed, and then, a quantitative analysis to acquire a mass spectrum is performed.

According to the conventional procedure of the quantitative analysis, a standard molecule is first analyzed in some concentrations. Then, changes over time of the ion intensity (mass chromatogram) with respect to m/z (mass/charge ratio) of ions originated from the standard molecule are acquired to determine peak areas of the mass chromatograms. A calibration curve is fabricated from the relation of the peak areas and the concentrations of the sample substance. Next, the same substance having an unknown concentration is analyzed to determine peak areas of a mass chromatogram. The substance concentration corresponding to the peak areas of the mass chromatogram is determined based on the fabricated calibration curve. Since this method has a precondition that a standard molecule is procured in advance to fabricate a calibration curve, the application to unknown components as objects of marker searches is difficult.

Patent Document 1 describes a method of performing a comparative quantitation on unknown components whose calibration curves cannot be fabricated, to search markers. This method involves first acquiring data for the analysis on a standard sample containing various components, then acquiring data for the analysis on another sample expected to contain the same components, and calculating the ion intensity ratio (or the peak area ratio) for each component. Then, standard ion intensity ratio is determined, and the ion intensity ratio for the each component is normalized using the value of the standard ion intensity ratio. Thereby, the comparative ion intensity ratio for the each component can be determined, and a component (marker candidate) exhibiting an outstanding variation in the ion intensities can be specified. The identification of a marker candidate separately needs an analysis of preferentially performing a tandem mass spectrometry.

For unknown components whose calibration curves cannot be fabricated, the comparative quantitation can be performed by using the isotope labeling technique. That is, a comparative quantitative analysis can be performed by mixing a sample containing various components and an isotope-labeled standard sample (Non-patent Document 1). An isotope-labeled component is simultaneously detected with an unlabeled component, but since values of m/z of detected ions are different by a predetermined value, comparing the ion intensities (or peak areas) in a mass chromatogram of the ion pair enables determination of the concentration ratio of the each component. Employment of this means enables performance of the quantitation with no problem. However, this means not only has a limitation on the types of samples applicable, but also requires much time and costs. Hence, in marker searches, the isotope labeling technique is not employed in many cases.

For an interface of an LC/MS, spray ionization methods such as the electrospray ionization method (ESI), the atmospheric pressure chemical ionization method (APCI), the atmospheric pressure photoionization method (APPI), and the like are used. In an interface using a spray ionization method such as ESI, the pneumatically assisted ESI or the sonic spray ionization method (SSI), quantitative analysis-inhibitory factors named as the matrix effect, the ion suppression and the ion enhancement are known to occur. The matrix effect and the ion suppression are phenomena in which scrambling for charges between components as described below cause variations in ion intensities. Even in the case of performing a comparative quantitative analysis as described in Patent Document 1, if quantitative analysis-inhibitory factors such as the matrix effect and the ion suppression occur, analysis results of data for the analysis may lose the reliability. In this connection, the matrix effect is a phenomenon in which in the case where a sample contains a large amount of ionic components, the ion intensity is reduced, and the matrix effect can be avoided if desalting is sufficiently carried out in preparation of a sample.

The ion suppression occurs in the case where the amount of object components to be ionized is equal to or more than the maximum value of the ion amount which can be generated in the interface (ionization unit). If this phenomenon occurs, scrambling for charges between various components occurs, and the ionization efficiency is decreased depending on chemical properties and amounts of each component. As a result, the relation between the ion intensities to be detected and component concentrations loses linearity (Non-patent Document 2). The maximum value I of ion amounts which can be generated has, if Q represents a liquid flow rate; κ represents an electric conductivity of a liquid; and γ represents a surface tension, the following relation:

I=β(ε)(Qκγ/ε)^{1/2} (1)

wherein β is a constant; and ε is a dielectric constant of the liquid. In order to beforehand prevent the ion suppression from occurring, it is indicated from the expression (1) that raising the electric conductivity κ of a liquid high is effective. However, too high an electric conductivity κ decreases the ion generation efficiency. Hence, it is desirable that κ be set in the range of being capable of generating ions efficiently by addition of an acid and the like to a mobile phase. In other words, since the electric conductivity κ needs to satisfy two contradictory necessities, the electric conductivity κ cannot actually be made high enough to reduce the ion suppression. Therefore, it is difficult to effectively prevent the ion suppression phenomenon regardless of conditions.

The problem as described above may occur not only in the spray ionization method such as ESI but also in other interfaces in LC/MS such as the atmospheric pressure chemical ionization method (APCI) and in ionization units of GC/MS. This is because the maximum ion amount which can be generated in an interface (ionization unit) has an upper limit.

On the other hand, the ion enhancement is caused by an increase in the maximum ion amount which can be generated in an interface (ionization unit) due to an increase in ionic components contained in a sample. As a result, the ionization efficiency is increased depending on chemical properties and amounts of each component, and the ion intensity to be detected increases, which is a phenomenon of the ion enhancement.

Methods for detecting the occurrence of quantitative analysis-inhibitory factors such as the ion suppression include monitoring of the ion intensity using an internal standard. For example, Non-patent Document 3 describes an evaluation method of the sample preparation by using an isocratic LC, (flow rate: 0.25 mL/min), whose mobile phase component is constant, and introducing an internal standard by infusion (flow rate: 5 μL/min) from the downstream side of a separation column. In the case where a sample is not sufficiently purified, quantitative analysis-inhibitory factors such as the ion suppression occur due to influences by salts and the like contained in the sample right after the introduction of the sample, and the intensity of ions originated from the internal standard decreases. Monitoring this ion intensity enables detection of quantitative analysis-inhibitory factors such as the ion suppression and the matrix effect. However, since this method ionizes a sample after the sample has been passed through a relatively long passage after the LC separation, in the case where the LC flow rate is small, the method is liable to give a decreased separation precision; and the method is effective for a semi-micro LC, a general-purpose LC and the like, whose LC flow rate is high, but the method is difficult to apply to separation means such as a micro LC and a nano LC (capillary LC), whose LC flow rate is low. Additionally, no internal standard has been optimized.

In order to suppress the occurrence of quantitative analysis-inhibitory factors, it is necessary that the sample preparation be modified to raise the purity of a sample to remove impurities and the like, which become quantitative analysis-inhibitory factors in the sample, or the separation condition in LC be modified and the separation be carried out or otherwise spending a more time to reduce the types of various components contained in the separated components.

Patent Document 1: U.S. Pat. No. 6,835,927

Non-patent Document 1: Y. Ishihara, T. Sato, T. Tabata, N. Miyamoto, K. Sagane, T. Nagasu, Y. Oda, Quantitative mouse brain proteomics using culture-derived isotope tags as internal standard, Nature Biotechnology 23 (2005) 617-621.

Non-patent Document 2: K. Tang, J. S. Page, R. D. Smith, Charge competition and the linear dynamic range of detection in electrospray ionization mass spectrometry, Journal of American Society for Mass Spectrometry 15 (2004) 1416-1423.

Non-patent Document 3: R. Bonfiglio, R. C. King, T. V. Olah, K. Merkle, The effects of sample preparation methods on variability of the electrospray ionization response for model drug compounds, Rapid Communications in Mass Spectrometry 13 (1999) 1175-11885.

### DISCLOSURE OF THE INVENTION

### Problems to be Solved by the Invention

As described hitherto, in marker searches, it is required that samples originated from disease subjects and healthy subjects be compared to extract variant components; unknown component substances composed of a large number of types constituting the variant components be identified with high precision; and the quantitative analysis of the component substances be performed with high sensitivity/high precision without being influenced by quantitative analysis-inhibitory factors such as the ion suppression phenomenon. Moreover, it is required that the series of analyses be performed in as short a time as possible, that is, a high throughput is required. It is also needed that the series of analyses be performed in as low a cost as possible.

For the requirements, since the analysis using a calibration curve, which is conventional means for the quantitative analysis, needs to acquire calibration curve data from a standard molecule in advance, the analysis cannot be applied to quantitative analyses containing unknown substances. The analysis using the isotope labeling technique as described in Non-patent Document 1 also limits the types of samples, and requires much time and a high cost. The comparative quantitation means described in Patent Document 1 cannot avoid an influence of the variation in the ion intensity due to quantitative analysis-inhibitory factors, so there arises a problem that the precision of the analysis result decreases.

Then, performing analyses not using the isotope labeling technique and not being influenced by quantitative analysis-inhibitory factors such as the ion suppression is an object for marker searches. However, in the case of performing the quantitation without using the isotope labeling technique, if quantitative analysis-inhibitory factors occur, there arises a need for reperforming the analysis. Hence, making the number of times of the qualitative analysis and that of the quantitative analysis as few as possible is important from the viewpoint of cost and speed.

For achieving a high throughput, there are problems as follows. Marker searches need a quantitative analysis to acquire a mass spectrum without performing the tandem mass spectrometry and a qualitative analysis to perform a tandem mass spectrometry for the identification. Additionally, samples composed of very many components are analyzed in many cases, and in this case, it is difficult in many cases to perform the qualitative analysis for all the components detected by one time of the analysis (JP Patent Publication (Kokai) No. 2005-091344A). This is because the throughput of the tandem mass spectrometry is limited. Therefore, there arises a need for many times of tandem mass spectrometry, and the throughput of a series of marker searches cannot be raised.

As detection means of quantitative analysis-inhibitory factors, since means described in Non-patent Document 3 cannot secure a precision in the quantitative analysis using LC having a low liquid flow rate and gradient mode LC, there is a problem that the means cannot perform high-sensitive analyses by LC having a low liquid flow rate, and analyses of trace amounts of samples.

In the case of a low LC flow rate, an internal standard needs to be injected from the upstream of a separation column, but therefor, the internal standard needs not to be adsorbed on the separation column. This need is a very important problem not only in an isocratic mode, in which the mixing ratio of organic solvents in an LC mobile phase is constant, but also in a gradient mode, in which the ratio changes in terms of time. Hence, the chemical properties of the internal standard need to be fully considered.

Further, in order to detect the occurrence of quantitative analysis-inhibitory factors such as the ion suppression, the mixing ratio of organic solvents in an LC mobile phase needs to be considered from the viewpoint of chemical properties of an internal standard. That is, the case of an aqueous mobile phase having a very low organic solvent ratio, and the case of a mobile phase having a very high organic solvent ratio are believed to be different in optimum chemical properties of the internal standard.

An object of the present invention is to solve the above-mentioned problems, and to perform the qualitative analysis and quantitation not using the isotope labeling technique and not being influenced by quantitative analysis-inhibitory factors and with high sensitivity and high throughput. The object of the present invention is to provide an analysis method for acquiring reliable data in a smallest number of times of qualitative and quantitative analyses without using the isotope labeling technique.

Another object of the present invention is to provide an internal standard to detect the occurrence of quantitative analysis-inhibitory factors.

Further another object of the present invention is to provide an automatic analyzer and an automatic diagnosing apparatus using an internal standard to detect the occurrence of quantitative analysis-inhibitory factors. This is because it is believed to be necessary to detect the occurrence of quantitative analysis-inhibitory factors in the case where a chemical analog expected to have chemical properties similar to an object substance for the analysis is quantitatively analyzed as a standard reagent.

### Means for Solving the Problems

In order to solve the above-mentioned problems, means for the analysis described below is provided. That is, first, an internal standard to be detected simultaneously with a component for the analysis is mixed in a mobile phase or an eluted liquid of a liquid chromatograph; and a mass chromatogram of ions originated from the internal standard is acquired under the condition where no quantitative analysis-inhibitory factors occur, and recorded in a data analysis unit. Typically, the blank sample containing no sample for the analysis is analyzed. Then, a sample for the analysis is mixed; data for the analysis of the sample are acquired; and at this time, the intensity of ions originated from the internal standard is compared with that in the analysis of the blank sample in an analysis real time in the data analysis unit. At this time, if an inconsistency is detected between the ion intensities, quantitative analysis-inhibitory factors are determined to have occurred in mixing of the sample for the analysis; and in this case, since the precision of the qualitative analysis result decreases due to the quantitative analysis-inhibitory factors, the analysis mode is changed from the quantitative analysis mode taking a low preference to the tandem mass spectrometry to the qualitative analysis mode taking preference to the tandem mass spectrometry. Then if the intensity of ions originated from an internal standard becomes consistent with that of a blank sample in the analysis real time by decreasing the mixing amount of a sample for the analysis, or otherwise, the analysis mode is again changed to the quantitative analysis mode. In the case where there arises a time region in a mass chromatogram where the intensities of ions originated from an internal standard are consistent, data for the analysis of the sample in the time region of the consistency are acquired as effective data for the analysis. In this means for the analysis, an internal standard to be used is a substance having properties stably detected during the analysis real time.

As a substance sensitively reacting to quantitative analysis-inhibitory factors such as the ion suppression, an internal standard described below is provided. That is, in the analysis of positive ion, and in the case where a mobile phase is an aqueous one having a low organic solvent ratio therein, a substance is provided which has an isoelectric point or an (acid) dissociation constant not remarkably lower than pH (hydrogen ion concentration) of the mobile phase, and has a high hydrophilicity. Then in the case of a high organic solvent ratio, a substance is provided which has an isoelectric point or a dissociation constant not remarkably lower than pH of the mobile phase, and has a hydrophobicity. On the other hand, in the analysis of negative ion, and in the case where a mobile phase is an aqueous one having a low organic solvent ratio therein, a substance having a basicity and a high hydrophilicity is provided. That is, a substance is provided which has an isoelectric point or dissociation constant of higher than 8, and a low hydrophobicity. In the case of a high organic solvent ratio, a substance having a high basicity and a hydrophobicity is provided.

In the case of using a liquid chromatograph in a gradient mode in which the organic solvent ratio in a mobile phase varies in terms of time, an internal standard having a high hydrophilicity and an internal standard having a hydrophobicity are concurrently used according to the variation range of the organic solvent ratio. By properly using the ion intensity information of ions originated from the internal standards according to the organic solvent ratio in a mobile phase, and reflecting the information on the analysis result, a quantitative analysis with high precision can be performed.

In the case of switching positive and negative ion detection modes at a high speed in one time of LC/MS analysis for an analysis, both of internal standards for the analysis for positive ion and the analysis for negative ion having different isoelectric points or dissociation constants from each other are mixed in a mobile phase or an eluate, and data are then acquired. By properly using the ion intensity information of ions originated from the internal standards based on positive and negative ion mode, and reflecting the information on the analysis result, a quantitative analysis with high precision can be performed.

In order to further improve the efficiency, means is also provided in which two types of internal standards exhibiting largely different sensitivities to analysis-inhibitory factors are introduced; a sample for the analysis is mixed therein, and analyzed; and by comparing mass chromatograms of ions originated from both the internal standards, the occurrence of analysis-inhibitory factors is detected by one time of the analysis. As two types of internal standards having largely different sensitivities to analysis-inhibitory factors, two types of internal standards having different isoelectric points are selected.

Further, means is also provided in which one type of an internal standard is introduced; additionally a substance present in an analysis solution and capable of becoming a second internal standard is searched for to make a second internal standard; and by comparing mass chromatograms of the both, the occurrence of analysis-inhibitory factors is detected by one time of the analysis.

As an analyzer to solve the above-mentioned problems, an analyzer is further provided which has a mobile-phase introduction unit to mix an internal standard and introduce a mobile phase, and a sample introduction unit, a separation unit, an ionization/mass-analysis unit, a data analysis unit, and a display unit, and has means to acquire and save a first mass chromatogram of ions originated from an internal standard in the state of not being mixed with a sample for the analysis, and means to acquire and compare a second mass chromatogram of ions originated from the internal standard in the state of being mixed with the sample for the analysis, and means to collect data for the analysis in the case where the inconsistency between the first and the second mass chromatograms is a given value or less.

An apparatus is also provided which has means to acquire and compare mass chromatograms of a first and a second internal standards in the state that the both are mixed in a mobile phase, and to collect data for the analysis according to the comparison result. An apparatus also is further disclosed which, in the state that a first internal standard is mixed in a mobile phase, has means to monitor data for the analysis to search for another substance capable of becoming a second internal standard in an analysis solution, and acquires and compares mass chromatograms of the second internal standard obtained by the search and the first internal standard, and collects data for the analysis according to the analysis result.

An apparatus also is further disclosed in which by mixing an internal standard in a sample for the analysis, and performing an analysis of the mixture, the presence/absence of the occurrence of analysis-inhibitory factors is detected, and in the case where the factors are significantly detected, a protocol for preparing a sample for the analysis is partially altered and a reanalysis is performed.

The present description includes the subject described in the specification and/or the drawings of Japanese Patent Application 2008-096710, which is the basis of the priority to the present application.

### Advantages of the Invention

An internal standard is mixed in a mobile phase or an eluate of LC, and the blank sample is first analyzed under the condition where no analysis-inhibitory factors occur. Next, a sample for the analysis is analyzed, but at this time, by measuring the intensity of ions originated from the internal standard in the analysis real time, and comparing with an analysis result of the blank sample in the analysis real time, whether or not the analysis-inhibitory factors have occurred when the sample for the analysis has been mixed can be detected with high precision. Further, based on the inconsistency above, the error in quantitative data can be evaluated.

Data in a time region indicating a consistency by comparison of mass chromatograms of ions originated from internal standards of the blank sample and the mixed sample for the analysis are judged not to be influenced by analysis-inhibitory factors, and data for the analysis of the sample for the analysis in the time region where the ion intensities are consistent with each other are acquired as effective data for the analysis, thereby enabling elimination of wasteful analysis time, and improve the analysis efficiency.

By introducing two types of internal standards, and acquiring and comparing mass chromatograms by one time of the analysis, the occurrence of analysis-inhibitory factors can be detected within the real time of one time of the analysis, thereby enabling further reduction in the analysis time.

By mixing an internal standard in a mobile phase of LC in advance, micro LC and nano LC (capillary LC), whose liquid flow rate is low, can be used for the quantitative mass spectrometry. This exhibits an advantage to a high-sensitive analysis, and enables analysis of a trace amount of a sample.

In the case where quantitative analysis-inhibitory factors occur, since very many components are detected simultaneously in many cases, by preferentially performing a qualitative analysis, the total number of times of analyses can be reduced, enabling achievement of a high throughput.

The identification of a component for the detection needs to hold the mass precision of a mass spectrometer high. However, in data acquisition using LC, variations in m/z values are detected in the analysis in some cases. Then, by always monitoring m/z values of ions originated from an internal standard (known substance) detected, the m/z value of ions for the detection can be corrected to a right m/z value. Thereby, data for the analysis having an extremely high mass precision can be acquired.

In the case where no quantitative analysis-inhibitory factors can be confirmed to occur, if the ion intensity (mass chromatogram area) of ions for the detection is normalized based on the intensity of ions originated from an internal standard, the comparison between data can be carried out with high precision. This is because the ion intensity varies more or less for each analysis in some cases.

In a mass chromatogram corresponding to an internal standard, and in the case where the ion intensity decreases below a predetermined inconsistency (threshold), the occurrence of quantitative analysis-inhibitory factors such as the ion suppression is detected. Since the decreasing rate gives the upper limit of the decreasing rate of the intensities of other ions detected during the time, the decreasing rate can be reflected to errors in intensities or areas of the other ions. By contrast, in a mass chromatogram corresponding to an internal standard, and in the case where the ion intensity increases above a predetermined inconsistency (threshold), the occurrence of quantitative analysis-inhibitory factors such as the ion enhancement is detected. Since the increasing rate gives the lower limit of the increasing rate of the intensities of other ions detected during the time, the increasing rate can be reflected to errors in intensities or areas of the other ions.

Further in an automatic analyzer and a diagnosing apparatus, and in the case where quantitative analysis-inhibitory factors such as the ion suppression are detected, by partially altering a method for preparing a sample for the analysis, and performing a reanalysis, a quantitative analysis can be performed under the condition where no quantitative analysis-inhibitory factors are detected.

Additionally, in an automatic analyzer and a diagnosing apparatus, by using the information of the ion intensity of ions originated from an internal standard and the ion intensity of ions originated from a standard molecule, a presumed (corrected) value of quantitative data and an error thereof can be reflected to output data.

### BRIEF DESCRIPTION OF THE DRAWINGS

FIG. 1 is a constitution diagram of an Example in a mass spectrometry system according to the present invention.

FIG. 2 is a mass chromatogram of ions originated from an internal standard in typical blank-sample data for the analysis.

FIG. 3 is a diagram showing a comparison of mass chromatograms of ions originated from internal standards in data for the analysis of a blank sample and a sample for the analysis, and an example of detection of the occurrence of quantitative analysis-inhibitory factors, in an Example in a mass spectrometry system according to the present invention.

FIG. 4 is a diagram showing a comparison of mass chromatograms of ions originated from internal standards in data for the analysis of a blank sample and a sample for the analysis, and an example of a large-scale occurrence of quantitative analysis-inhibitory factors.

FIG. 5 is a diagram showing a comparison of mass chromatograms of ions originated from two types of internal standards in data for the analysis of a sample for the analysis, and an example of detection of the occurrence of quantitative analysis-inhibitory factors, in an Example, in which the two types of internal standards were used, in a mass spectrometry system according to the present invention.

FIG. 6 is an illustrative diagram of a screen of a data analysis unit, or a screen of a control unit of a mass spectrometer in an Example in a mass spectrometry system according to the present invention.

FIG. 7 is a constitution diagram of an Example in another mass spectrometry system according to the present invention.

FIG. 8 is a diagram showing an example of the time dependency of measured m/z of ions originated from an internal standard in a mass spectrometry system according to the present invention.

FIG. 9 is a diagram interpreting analysis steps in First Example in the present invention.

FIG. 10 is a diagram interpreting analysis steps in Second Example in the present invention.

FIG. 11 is a diagram interpreting analysis steps in Third Example in the present invention.

FIG. 12 is comparative diagrams of (a) a total ion chromatogram, and (b) a mass chromatogram of ions originated from an internal standard, acquired using a mass spectrometry system according to the present invention.

FIG. 13 is comparative diagrams of mass spectra acquired in the retention time (1) using a mass spectrometry system according to the present invention.

FIG. 14 is comparative diagrams of mass spectra acquired in the retention time (2) using a mass spectrometry system according to the present invention.

FIG. 15 is a diagram showing the relation between the peak area and the injection amount with respect to ions detected in the retention times (1) and (2).

FIG. 16 is an illustrative plan view of an automatic analyzer according to the present invention.

FIG. 17 is a sectional illustrative diagram of a turn table 301 and a turn table 305 of an automatic analyzer according to an embodiment of the present invention.

### DESCRIPTION OF SYMBOLS

101 MOBILE-PHASE INTRODUCTION UNIT
102 SAMPLE INTRODUCTION UNIT
103 SEPARATION UNIT
104 IONIZATION/MASS-ANALYSIS UNIT
105 DATA ANALYSIS UNIT
106 DISPLAY UNIT
107 CONTROL UNIT FOR THE ANALYSIS MODE
108 CONTROL SYSTEM
109 SELECTION BUTTON FOR THE ANALYSIS MODE
110 POINTER
111 SYRINGE PUMP
112 POINTING DEVICE
113 DATA STORAGE MEANS
114 LEVEL ADJUSTMENT MEANS
115 MEANS TO CALCULATE AND COMPARE THE INCONSISTENCY
116 DETECTION MEANS OF THE TIME REGION FOR CONSISTENCY
117 COLLECTION MEANS OF DATA FOR THE ANALYSIS
201 MOBILE PHASE A
202 MOBILE PHASE B
203 MOBILE PHASE C
204 INTERNAL STANDARD
205 BLANK SAMPLE OR SAMPLE FOR THE ANALYSIS
301 TURN TABLE
302 SOLID-PHASE EXTRACTION CARTRIDGE
303 CARTRIDGE-HOLDING CONTAINER
304 PRESSURE LOADING UNIT
307 LIQUID SURFACE SENSOR
308 ROTARY ARM
309 ROTARY ARM
310 REAGENT TANK
311 REAGENT CONTAINER
312 CARTRIDGE STORAGE UNIT
313 SAMPLE TRANSPORTATION UNIT
314 ROTARY ARM
315 PUMP
316 SAMPLE INTRODUCTION UNIT
317 IONIZATION UNIT
318 MASS-ANALYSIS UNIT
319 CONTROL UNIT
1050 ANALYSIS STEPS OF BLANK SAMPLE
1051 REAL-TIME ANALYSIS CONTROL STEPS
1201 ION INTENSITY OF IONS ORIGINATED FROM INTERNAL STANDARD
1201a ION INTENSITY (DATA a) OF IONS ORIGINATED FROM INTERNAL STANDARD AT ANALYSIS OF BLANK SAMPLE
1201b ION INTENSITY (DATA b) OF IONS ORIGINATED FROM INTERNAL STANDARD AT ANALYSIS OF SAMPLE FOR THE ANALYSIS
1202a ION INTENSITY OF IONS ORIGINATED FROM FIRST INTERNAL STANDARD
1202b ION INTENSITY OF IONS ORIGINATED FROM SECOND INTERNAL STANDARD
1401 THEORETICAL VALUE OF m/z OF INTERNAL STANDARD
1402 MEASURED VALUE OF m/z OF INTERNAL STANDARD
1403 CORRECTED VALUE OF m/z OF SAMPLE FOR THE ANALYSIS
1404 MEASURED VALUE OF m/z OF SAMPLE FOR THE ANALYSIS

### BEST MODE FOR CARRYING OUT THE INVENTION

Hereinafter, embodiments according to the present invention will be described by way of drawings.

### EXAMPLE 1

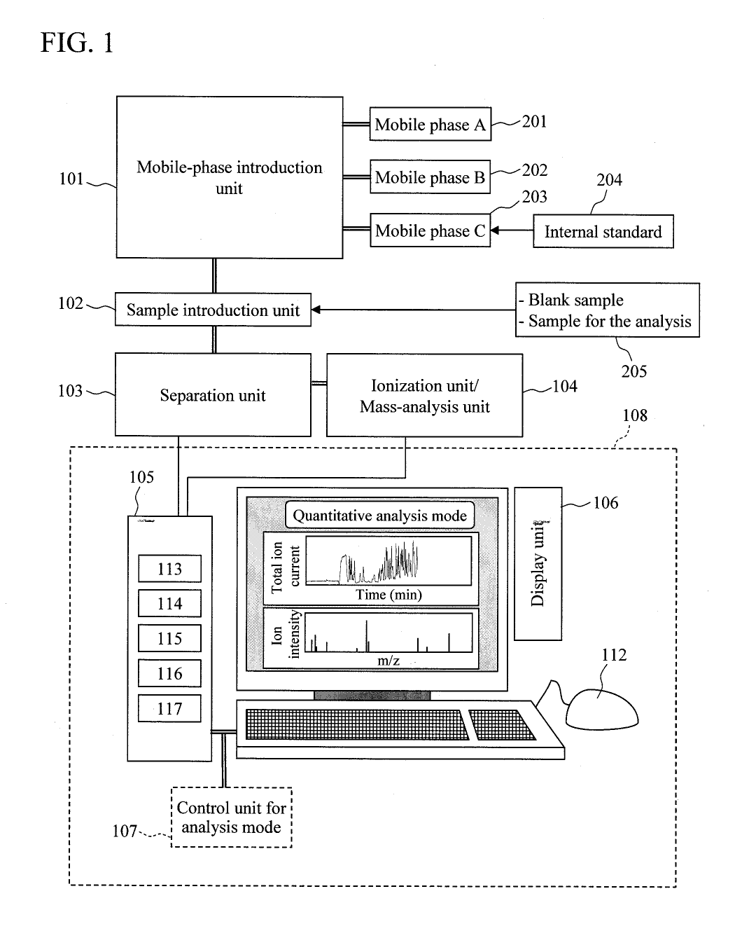

FIG. 1 shows a constitution diagram of an Example in a mass spectrometry system according to the present invention. The system comprises a mobile-phase introduction unit 101, a sample introduction unit 102, a separation unit 103, an ionization/mass-analysis unit 104, a data analysis unit 105, a display unit 106, and a control unit of analysis mode 107. The data analysis unit 105, the display unit 106 and the control unit of analysis mode 107 are put together as a control system 108. Each unit of the mobile-phase introduction unit 101, the sample introduction unit 102, the separation unit 103, the ionization/mass-analysis unit 104 and the control system 108 is collectively controlled by a system control unit to supervise the whole system, and desired operations are achieved while information of control states is bilaterally exchanged between each unit of the system. A mobile phase is introduced from the mobile-phase introduction unit 101; a sample 205 composed of various components is introduced through the sample introduction unit 102; and the separation is carried out in the separation unit 103 composed of separation devices such as a liquid chromatograph (LC). A mobile phase A (201), a mobile phase B (202) as well as a mobile phase C (203) are prepared to the mobile-phase introduction unit 101. The mobile phases A and B are ones used in common reverse-phase chromatograph, and a typical mobile phase A (201) is 2% acetonitrile in water (0.1% formic acid); and a typical mobile phase B (202) is 98% acetonitrile in water (0.1% formic acid).

The mobile phase C (203) is one in which a specified amount of an internal standard 204 is added to the mobile phase A. In the case where, from the start, internal standards are added to the mobile phases A and B, the mobile phase C is unnecessary. The important point is that the internal standard 204 is introduced to the separation unit 103 always in a constant concentration. Samples (blank sample, sample for the analysis, and the like) 205 introduced to the sample introduction unit 102 are separated in the separation unit 103, introduced to the ionization/mass-analysis unit 104 sequentially as separated components, and ionized and mass analyzed. The output of the mass analysis unit is introduced to the data analysis unit 105, and stored and data treated as data for the analysis. The data analysis unit 105 shown in FIG. 1 is provided with the display unit 106, which displays information indicating the priority in the tandem mass spectrometry, including “quantitative analysis-preferential mode” and “qualitative analysis-preferential mode” in the analysis real time. Additionally, the display unit 106 displays the time dependency of the total ion current (total ion current chromatogram), and analysis situations such as the latest mass spectrum or tandem mass spectrometry spectrum. The control of the mass-analysis unit 104 may be carried out by the data analysis unit 105, or may be carried out by a separate information processing facility (control unit for the analysis mode 107) as shown by a dashed line. Alternatively, the control may be carried out using a constitution in which the display unit 106 has a selection button for the analysis mode, as described later, and an operator can switch the modes.

The outline of the analysis procedure is as follows. First, mobile phases A, B and C as described before are prepared; while the ratio of the mobile phase C containing an internal standard is held at a constant value, for example, 3%, the mixing ratio of the mobile phase A and the mobile phase B is set at an initial constant value, and is varied over the time. Typically, the mixing ratio is linearly varied, for example, such that the mixing ratio at the start of the mobile phases A and B is set at 92% and 5% (C is fixed at 3%), and the ratio at the end after 60 min is set at 47% and 50%. The values of this mixing ratio at the start and the end, the mixing time and the like are just an example, and can suitably be changed. The gradient mode, in which the mixing ratio of the mobile phases A and B is varied in terms of time, is means often used in LC separation. In LC separation in the pharmacokinetic analysis requiring a high throughput analysis, the isocratic mode, in which the mixing ratio of the mobile phases A and B is fixed in terms of time, is often utilized.

As an internal standard, a desired substance is selected and prepared in advance according to the conditions described later. An internal standard is selected so as to be always detected in an LC retention time range where the internal standard is detected simultaneously with a component for the analysis, and mixed in a mobile phase or a component of a mobile phase; a blank sample is introduced from the sample introduction unit 102; and a mass chromatogram of ions originated from the internal standard is acquired, and recorded in the data analysis unit 105. In the data analysis unit 105, the data storage means 113 constituted of a data storage medium and the like is disposed. At this time, data need to be acquired under the conditions where no quantitative analysis-inhibitory factors occur. Therefore, the same substance as a mobile phase A, or pure water is introduced as a blank sample to be introduced through the sample introduction unit 102, and no substance other than substances previously present in the mobile phase is mixed. Caution needs to be taken so the blank sample as to contain no impurities. In order for the internal standard itself to cause no ion suppression, the internal standard needs to be contained in only a minimum amount necessary for ion detection. Then, a sample for the analysis is introduced through the sample introduction unit 102 in place of the blank sample; and the data for the analysis of the sample mixed with the same amount of the internal standard is acquired, and recorded in the data analysis unit.

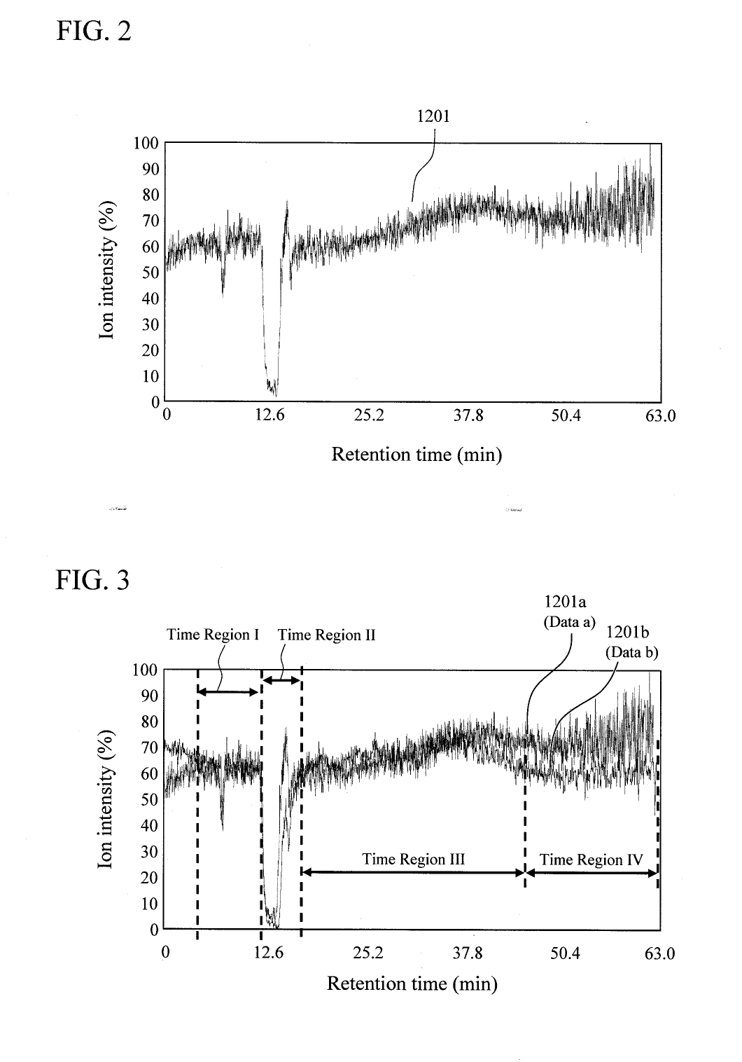

A typical mass chromatogram of ions originated from an internal standard is shown in FIG. 2. The abscissa indicates the retention time of LC; and the ordinate indicates the ion intensity. The data is acquired using a liquid chromatograph/mass spectrometer (LC/MS). Since LC in LC/MS usually uses a reverse-phase column as a separation column, it is desirable that the internal standard have a high hydrophilicity in such a degree that the internal standard can pass through the reverse-phase column without adsorption. If the hydrophilicity is very high, since ions originated from the internal standard contained in the mobile phase are always stably detected in the retention time of the separation, the occurrence of quantitative analysis-inhibitory factors can always be monitored. In the example of FIG. 2, as the internal standard, a synthetic peptide whose amino acid sequence is SSSSSSK was used. As a blank sample, pure water was used. In the present Example, when the blank sample of pure water was introduced at a timing of the retention time of 0, pure water was eluted after 12.6 min. Hence, the ion intensity 1201 of ions originated from the internal standard in FIG. 2 drops at a retention time of 12.6 min, and ions originated from the internal standard come not to be detected. In this time range, components contained in the sample and not having being separated are eluted, but if the components are considered to be out of the object of the quantitation, even if the occurrence of quantitative analysis-inhibitory factors cannot be monitored, there arises no problem. By contrast, in the other time range, the ion intensity exhibits a very low dependency of the ion intensity on the retention time, and changes only smoothly. This can interpret that the ionization efficiency of the internal standard does not change outstandingly due to the change in the components of the mobile phase.

The principle of the ion suppression being a quantitative analysis-inhibitory factor will be described simply hereinafter. In the spray ionization method such as the electrospray ionization method, first, charged liquid droplets of nearly micron size are produced by spraying of the liquid. In the charged liquid droplets, ions of a liquid phase distribute on the liquid droplet surface by the electrostatic repulsive force. Then, solvent molecules evaporate from the charged liquid droplets, and gaseous ions are produced from the charged liquid droplets through the ion evaporation process or the charge residue process. Hence, the major origin of the gaseous ions to be detected by a mass spectrometer is ions of a liquid phase present on the surface of the charged liquid droplets. The size of the charged liquid droplets decreases due to the evaporation of the solvent molecules, and the charge density of the surface increases. Thereby, also in a non-charged object substance for the analysis in the vicinity of the liquid droplet surface, the ionization (addition of protons, and the like) progresses. In the case where the amount of the object substance for the analysis is sufficiently small with respect to the charge of the liquid droplet surface, the ionization efficiency of the object substance for the analysis becomes constant. In the case where this condition is satisfied, the relation between the intensity of ions for the detection and the sample amount becomes constant. However, in the case where the amount of the object substances for the analysis is equal to or more than the charge of the liquid droplet surface, the supply of the charge to the object substance for the analysis becomes partially insufficient, and scrambling of the charge between the object substances for the analysis occurs on the liquid droplet surface. As a result, the efficiency of production of gaseous ions from the charged liquid droplet varies (decreases). That is, this is the occurrence of the ion suppression. The decreasing rate of the ionization efficiency depends on physicochemical properties of the object substance for the analysis. According to the ion production process described above, the main factors characterizing an object substance for the analysis susceptible to the influence of the ion suppression are considered to be two points of 1) the lowness of the degree of electrolytic dissociation in a liquid phase (or a property of charged liquid droplets charging to the reverse polarity), and 2) the easiness of access to the liquid droplet surface (the lowness of the surface activity). The lowness of the surface activity can be expressed in hydrophobicity and hydrophilicity. By contrast, components which electrolytically dissociate completely in a liquid phase can be present on the charged liquid droplet surface as ions, and are considered to be hardly susceptible to the influence of the ion suppression. On the other hand, the quantitative analysis-inhibitory factor such as the ion enhancement occurs due to a rapid increase of ionic substances. In this case, as a result of an increased charge of the liquid droplet surface, the ionization efficiency of an object substance for the analysis increases. The increasing rate of the ionization efficiency also depends on physicochemical properties of the object substance for the analysis, and factors characterizing the influence are the same as the case of the ion suppression.

In selection of an internal standard to monitor the occurrence of quantitative analysis-inhibitory factors, the present inventors have found for the first time that an isoelectric point or a dissociation constant (or acidity/basicity), and hydrophobicity/hydrophilicity of an internal standard can be used as indices. The isoelectric point refers to a pH at the time when an ampholyte compound exhibits an average charge of 0 as the whole compound. An internal standard having an isoelectric point lower than 7 is acidic, and was confirmed to be advantageous to the detection of quantitative analysis-inhibitory factors because it reacts sensitively to the quantitative analysis-inhibitory factors in the analysis for positive ion. Generally, an acidic molecule having a dissociation constant (pK) lower than 7 reacts sensitively to quantitative analysis-inhibitory factors in the analysis for positive ion, which is advantageous to the detection of the quantitative analysis-inhibitory factors. By contrast, a basic molecule having a dissociation constant (pK) or an isoelectric point higher than 7 reacts sensitively to quantitative analysis-inhibitory factors in the analysis for negative ion, which is advantageous to the detection of the quantitative analysis-inhibitory factors. On the other hand, with respect to the hydrophobicity (or hydrophilicity), in a mobile phase having a low ratio of an organic solvent, it is a necessary condition that an internal standard has a lower hydrophobicity (or higher hydrophilicity) than G or A being an amino acid, which has an average hydrophobicity (or hydrophilicity). In a mobile phase having a ratio of an organic solvent of more than 50%, it is a necessary condition that an internal standard has a higher hydrophobicity than G or A. In the case of a mobile phase used in the reverse-phase LC/MS, an acid such as formic acid is added to the mobile phase to adjust pH thereof to about 3 in many cases from the viewpoint of a balance between LC separability and ionization. Therefore, in the case where the isoelectric point is sufficiently lower than pH of a mobile phase, there arise a possibility that the production efficiency of positive ions becomes too low, which may be to be taken into account.

In the case of too low an ionization efficiency, an internal standard needs to be mixed in a mobile phase in a high concentration, so the internal standard is nor preferable. This is because, since the occurrence of quantitative analysis-inhibitory factors depends on the amount of substances to be ionized, the addition itself of the internal standard can possibly cause quantitative analysis-inhibitory factors. From the viewpoints of the above, in the case of analyzing positive ions using a mobile phase having a low ratio of an organic solvent, synthetic peptides (acidic peptides such as DSSSSS and EQQQQQ, the isoelectric points are 3.8 and 4.0, respectively) having a high hydrophilicity and an isoelectric point of 3 or higher and 8 or lower are most suitable as an internal standard. Even compounds (not peptides) having a dissociation constant of 7 or more can be of course used as an internal standard. The dissociation constant (pK) or the isoelectric point is most suitably 4 or lower. On the other hand, basic peptides (SSSSSK and SSKSSK, the isoelectric points are 8.5 and 10.0, respectively) having an isoelectric point of 8 or higher, basic compounds having a dissociation constant of 8 or higher, and the like can be similarly used as an internal standard. Here, basic compounds are less influenced by quantitative analysis-inhibitory factors than acidic compounds, which is disadvantageous to the detection, and additionally have a tendency of easily producing not only singly-protonated molecules but also multiply-protonated molecules. Polyprotonated molecules (polyvalent ions) may be subjected to deprotonation by the gas-phase ion-molecule reaction to become monovalent ions. This fact corresponds to the decrease of the ion intensity, and means that it may become difficult to distinguish from the detection of quantitative analysis-inhibitory factors.

Therefore, in the case of a mobile phase having a low ratio of an organic solvent, basic compounds having an isoelectric point of 8 or higher, which easily produce polyvalent ions, are unsuitable for the detection of quantitative analysis-inhibitory factors. Summarizing the above, in the case where positive ions are analyzed using a mobile phase having a low ratio of an organic solvent, substances most suitable for an internal standard are ones, which have a low hydrophobicity (a high hydrophilicity), and are acidic and have a low value of an isoelectric point or a dissociation constant in the range of 4 or lower and 2 or higher, and in which only a singly-protonated molecule is detected, that is, substances having an isoelectric point or a dissociation constant of about 2 to 8. Taking peptides as an example, amino acids having an isoelectric point of 3 or lower are D (isoelectric point: 2.8) only, and most of the components have an isoelectric point of 3 or higher. It is therefore conceivable that if an internal standard having a property of the isoelectric point or dissociation constant of about 3 is used, ions originated from the internal standard are most strongly influenced by quantitative analysis-inhibitory factors such as the ion suppression. It suffices if, as peptides utilizable as such an internal standard, peptides containing D and E, which are typical acidic amino acids, and S, Q, N and the like, which have a high hydrophilicity and hardly electrolytically dissociate, in the amino acid sequence are selected; and DSSSSS, ENNNNN and the like are suitable. (D and E have a high hydrophilicity, and a pK_{R} (side chain) of about 4.) On the other hand, in the case of analyzing negative ions, substances most suitable as an internal standard are ones having a high hydrophilicity (low hydrophobicity), and additionally a basicity and a high isoelectric point. It suffices if, as peptides utilizable as such an internal standard, peptides containing R and K, which are typical basic amino acids, and S, Q, N and the like, which have a high hydrophilicity, in the amino acid sequence are selected. R and K also have a high hydrophilicity, and additionally an isoelectric point of 9 or higher, and a pK_{R} (side chain) of 10 or higher. By contrast, S, Q and N not only have a high hydrophilicity, but also have a property of hardly electrolytically dissociating in a liquid phase. Examples of such peptides include KNNNNN and RNNNNN, whose isoelectric points are 8.75 and 9.75, which are 8 or higher, respectively. Of course, there is no reason that an internal standard must be a peptide, and any compound having the above-mentioned properties can be used similarly.

In the case of analyzing positive ions using a mobile phase having as high a ratio of an organic solvent as exceeding 50%, synthetic peptides having a hydrophobicity, and an isoelectric point of 8 or lower can be used as an internal standard. Particularly peptides and other compounds having an isoelectric point or a dissociation constant of 4 or lower are most suitable as an internal standard. On the other hand, basic peptides having an isoelectric point of 8 or higher, basic compounds having a dissociation constant of 7 or higher, and the like can similarly be used as an internal standard. However, basic compounds have smaller influence by quantitative analysis-inhibitory factors than acidic compounds, which is disadvantageous to the detection, and additionally have a tendency of easily producing not only singly-protonated molecules but also multiply-protonated molecules. Polyvalently protonated molecules (polyvalent ions) may be subjected to deprotonation by the gas-phase ion-molecule reaction, and converted to monovalent ions. This fact corresponds to the decrease of the ion intensity, and means that it may become difficult to distinguish from the detection of quantitative analysis-inhibitory factors.

Therefore, in the case of a mobile phase having a high ratio of an organic solvent, basic compounds having an isoelectric point of 8 or higher, which easily produces multiply-charged ions, are unsuitable for the detection of quantitative analysis-inhibitory factors. Summarizing the above, in the case of analyzing positive ions using a mobile phase having a high ratio of an organic solvent, substances most suitable as an internal standard are ones which have a hydrophobicity, and are additionally acidic and have low values of the isoelectric point or dissociation constant, and in which only singly-protonated molecules can be detected, that is, substances having an isoelectric point or a dissociation constant in the range of 2 to 8. Taking peptides as an example, amino acids having an isoelectric point of 3 or lower are D (the isoelectric point: 2.8) only, and most of components have an isoelectric point of 3 or higher. It is therefore conceivable that if an internal standard having a property of an isoelectric point or dissociation constant of about 3 is used, ions originated from the internal standard are most strongly influenced by quantitative analysis-inhibitory factors such as the ion suppression. It suffices if, as peptides utilizable as such an internal standard, peptides containing D and E, which are typical acidic amino acids, and G, F, L and the like, which have a hydrophobicity and are hardly electrolytically dissociated, in the amino acid sequence are selected, and acidic peptides such as FDFGF and EFGFGF (the isoelectric points are 3.8 and 4.0, respectively) are suitable. (D and E have a high hydrophilicity, and additionally have a pK_{R} (side chain) of about 4.) On the other hand, in the case of analyzing negative ions, substances most suitable as an internal standard are ones which have a hydrophobicity, and are basic and have an isoelectric point or a dissociation constant of 8 or higher. It suffices if, as peptides utilizable as such an internal standard, peptides containing R and K, which are typical basic amino acids, and G, F, and the like, which have a hydrophobicity, in the amino acid sequence are selected. R and K have a high hydrophilicity, and an isoelectric point of 9 or higher, and a pK_{R} (side chain) of 10 or higher. On the other hand, G, F and L not only have a hydrophobicity, but also have a property of hardly electrolytically dissociating in a liquid phase. Examples of such peptides include KGGGGG and RFFFFF, whose isoelectric points are 8.75 and 9.75, respectively, which are 8 or higher. Of course, there is no reason that an internal standard must be a peptide, and any compound having the above-mentioned properties can be used similarly.

In the case of using a liquid chromatograph in a gradient mode, the ratio of an organic solvent in a mobile phase varies in terms of time. Nevertheless, in the case where the ratio of an organic solvent is always 50% or less, an internal standard having a low hydrophobicity can be used. In the case where the ratio of an organic solvent is always 70% or more, an internal standard having a hydrophobicity can be used. However, in the case where the ratio of an organic solvent varies from 40% to 90%, use of only one of an internal standard having a low hydrophobicity and an internal standard having a hydrophobicity is not preferable to perform a quantitative analysis with high precision. In this case, concurrent use of the both is preferable. According to the ratio of the organic solvent in the mobile phase, the presence/absence of, and the degree (error) of the influence of the occurrence of quantitative analysis-inhibitory factors based on information of the ion intensities of ions originated from each of the internal standards are reflected to the analysis results, thereby enabling performance of a quantitative analysis with high precision. In this case, if the occurrence of quantitative analysis-inhibitory factors is detected based on information of the ion intensity of ions originated from one of the internal standards, even if the occurrence is not detected based on that of the other internal standard, the occurrence of quantitative analysis-inhibitory factors is confirmed. In the case where the occurrence of quantitative analysis-inhibitory factors is detected by ions originated from both the internal standards, the one having a larger variation can be reflected to the quantitative error. In the case of using an analysis mode in which positive and negative ion detection modes are switched at a high speed in one time of LC/MS analysis, data for the analysis of positive and negative ions can be acquired simultaneously. In this case, both of internal standards for the analysis for positive ion and for the analysis for negative ion are mixed in an LC mobile phase or an eluate to acquire data, and the information of the ion intensities of ions originated from the internal standards are separately used based on positive and negative ion mode, and reflected to the analysis results, thereby enabling a quantitative analysis with high precision.

Finally, the molecular weight of an internal standard needs to be examined. If m/z of ions originated from an internal standard overlaps on m/z of other ions for the detection to such a degree that the overlap cannot be distinguished by the mass resolving power of a mass spectrometer, there arises a possibility of false recognition in which the ion intensity originated from the internal standard has increased. In this case, as described later, the detection of the ion suppression becomes difficult. For example, in the analysis of peptides, if m/z of ions originated from an internal standard is 600 or more or 350 or less, it can be expected from experience that a possibility that the m/z overlaps on m/z of other ions for the detection is very low. In the case of analyzing a low-molecular compound, the compound of m/z of 500 or more is rare, and if m/z of ions originated from an internal standard is 400 or more, no problem is conceivable. Generally, since an internal standard having a higher molecular weight has a tendency of exhibiting a higher hydrophobicity, the molecular weight is desirably 1,000 or lower.

In the analysis using such an internal standard, the occurrence of quantitative analysis-inhibitory factors decreases or increases the ion intensity originated from the internal standard. At the same time, the ion intensities of other ions also may possibly decrease or increase. When the ion suppression occurs, the upper limit of the decreasing rate of the ion intensity becomes a deceasing rate of the ion intensity of ions originated from the internal standard. By utilizing this property, the decreasing rate of the ion intensity of ions originated from an internal standard can be included in the error as a maximum decreasing rate in a measurement value of the ion intensity of other components, and can be reflected to statistical processes of various data. Since actually, data for the analysis always contain a measurement error, it suffices that a threshold is set based on the error; the threshold is employed as an error in the case where the decreasing rate of the ion intensity of ions originated from an internal standard is lower than the threshold; and the decreasing rate of the ion intensity of ions originated from the internal standard is employed as an error in the reverse case. Similarly, when the ion enhancement occurs, the ion intensity of ions originated from an internal standard increases. This increasing rate can be included in the error as the lower limit of an increasing rate in a measurement value of the ion intensity of other components, and can be reflected to statistical processes of various data. Provided that values of the isoelectric point and the dissociation constant having being described herein are rough ones, and may involve an error of about 10% by experience.

The descriptions hitherto have been on the premise of analyses using a spray ionization method such as ESI, gas spray-assisted ESI and a sonic spray ionization method (SSI), but in the case of APCI, the proton affinity governing the gas-phase ion-molecule reaction is an important physical quantity instead of the isoelectric point and the dissociation constant. That is, setting the proton affinity of an internal standard low can make the internal standard most susceptible to quantitative analysis-inhibitory factors. For example, since the proton affinity of amino acids and the like is 200 kcal/mol or more, components having a lower proton affinity than the amino acids and the like, and a high hydrophilicity are candidates of an internal standard. The utilization of water (about 165 kcal/mol), methanol (about 180 kcal/mol), acetonitrile (about 187 kcal/mol) or the like contained in an LC mobile phase solvent is convenient. The decreasing rate of the ion intensity due to the occurrence of quantitative analysis-inhibitory factors can be treated in the same manner as in the case of ESI. Finally, a third requirement condition of an internal standard is that m/z of the ions is different from that of an object component for the analysis.

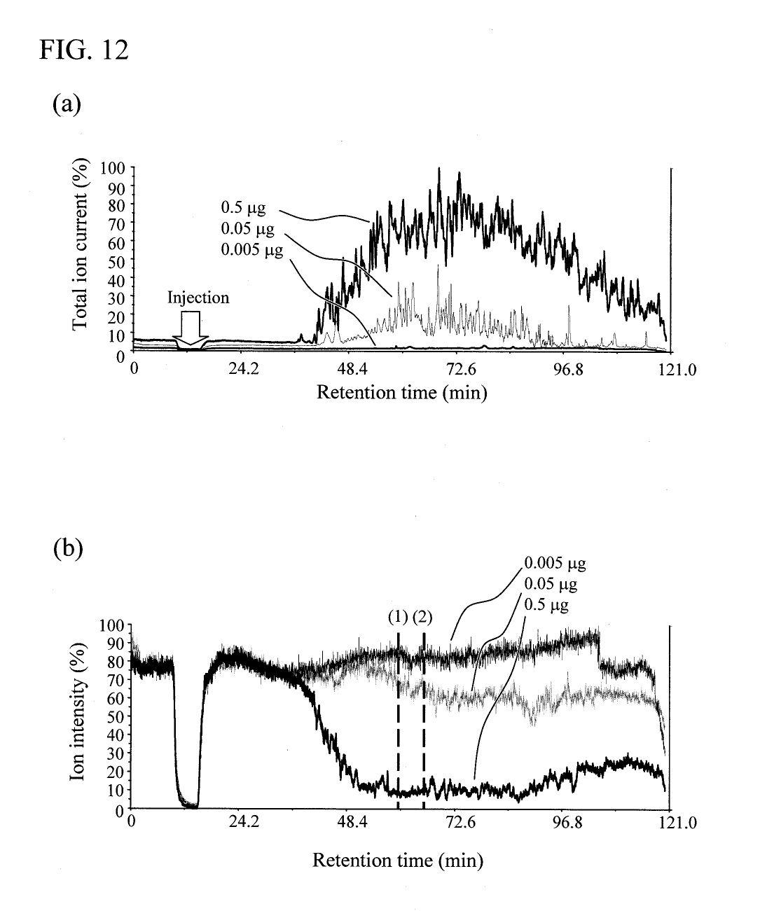

FIG. 12 shows an analysis example of a plasma sample. Total ion chromatograms in the case where the injection amount was changed by two digits from 0.5 μg to 0.005 μg are shown in (a) an overlapped fashion. Mass chromatograms of ions originated from an internal standard (DSSSSS) are shown in (b) an overlapped fashion. From this result, in the case where the injection amount was 0.005 μg, a decrease in the intensity of ions originated from the internal standard (DSSSSSS) is not observed. Hence, the result is considered to be equal to the analysis result of a blank sample, so this data for the analysis indicates no problem even if a quantitation is performed. However, in the case where the injection amount was 0.05 μg, the intensity of ions originated from the internal standard decreased by about 20 to 40% after 50 min of the retention time. Hence, other ion intensities also are considered to possibly decrease to the same level after 50 min of the retention time. In the case where the injection amount was 0.5 μg, the intensity of ions originated from the internal standard outstandingly decreases over the almost whole retention time region where separated components are detected. In the example of FIG. 12, LC separation was performed in a gradient mode. By contrast, in the case of performing LC separation in an isocratic mode, the composition of a mobile phase is constant. Hence, unless quantitative analysis-inhibitory factors occur, the ion intensity of ions originated from an internal standard is constant. In such a case, in a mass chromatogram of ions originated from an internal standard as shown in FIG. 12(b), the ion intensity indicates entirely the same ion intensity as a blank sample until a decrease of the ion intensity by injection of a sample at about 12 min is observed. Therefore, in such a case, there is no need for particularly saving the analysis result of the blank sample. The average ion intensity in the early retention time region can be treated in the same manner as the analysis result of the blank sample. If this time region is present for 2 min or more, the presence/absence of the occurrence of quantitative analysis-inhibitory factors can be detected with high precision.

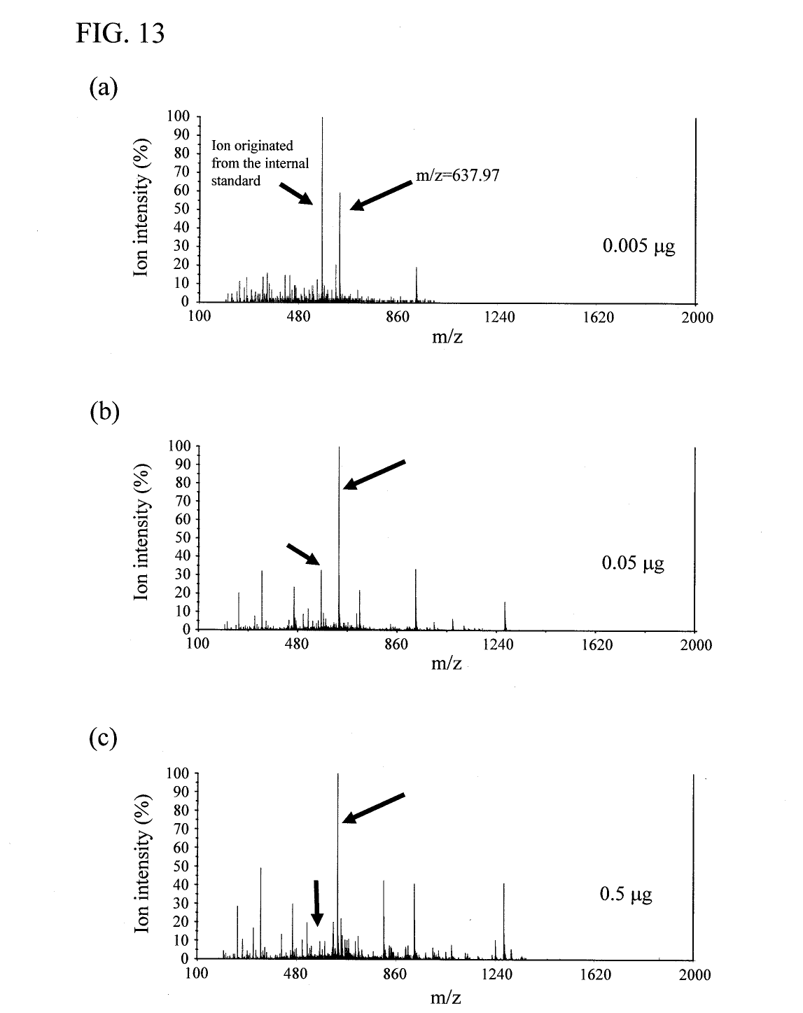

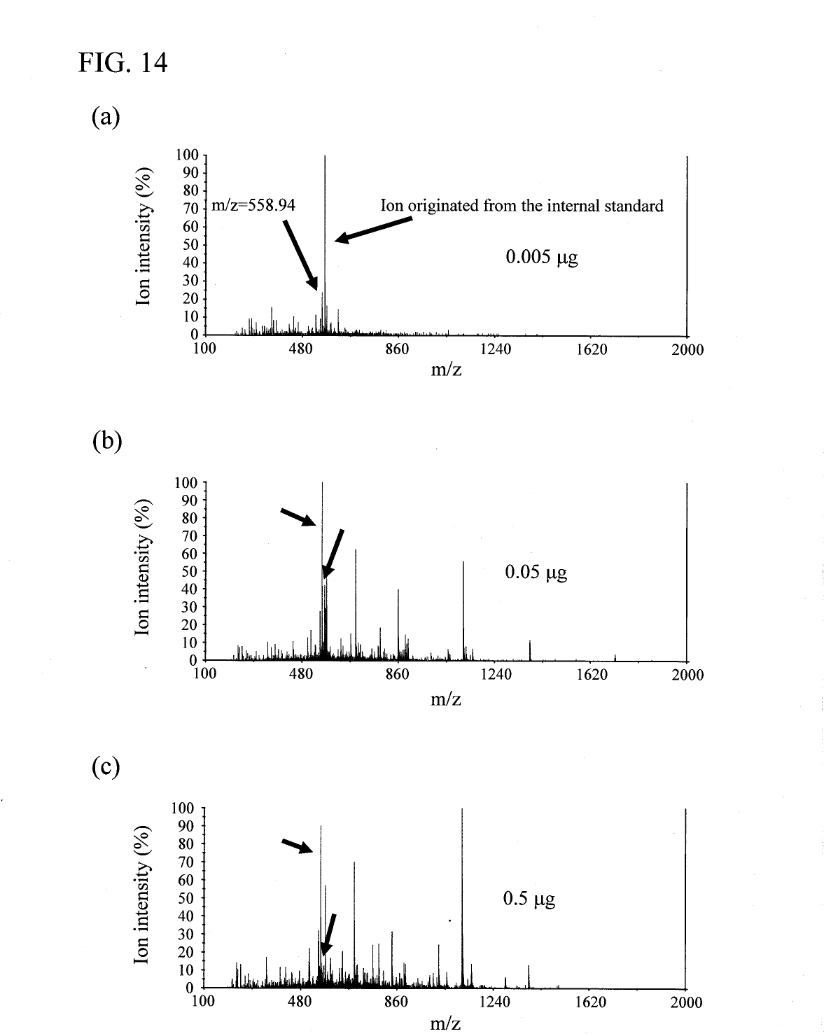

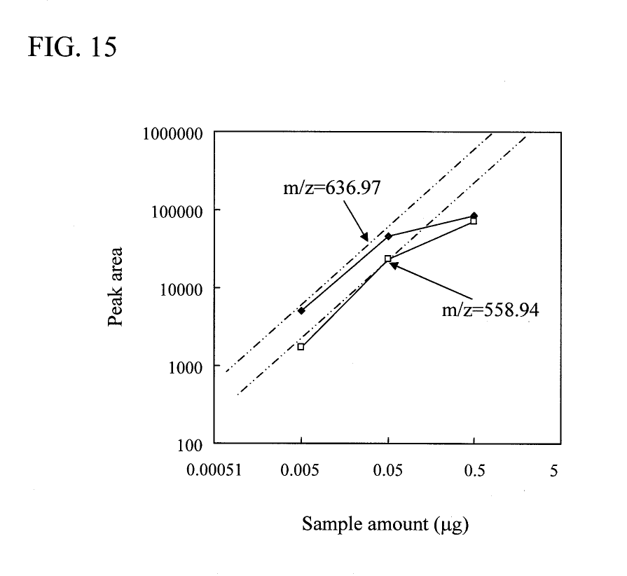

Comparison of mass spectra acquired at retention times indicated by (1) and (2) in FIG. 12 is shown in FIG. 13 and FIG. 14, which indicate that patterns of mass spectra acquired in the cases (c) where the injection amount was maximum are different from the results of the cases ((a) and (b)) where the injection amount was low. This difference can be interpreted as the occurrence of the ion suppression. Paying attention to ions detected in FIG. 13 and FIG. 14 (m/z=637.97 and 588.96, respectively), relations between areas of these ion peaks (obtained by integrating peak areas in mass spectra in the retention time direction) and the injection amounts are shown in FIG. 15.

Since this figure is double logarithm plots, the case where the plots can be fit to a straight line of 1 in slant allows for a quantitation. As shown in FIG. 15, for two types of ions described above, in the cases where the injection amounts were 0.005 and 0.05 μg, the data points can be plotted on a straight line of nearly 1 in slant, but in the case where the injection amount was 0.5 μg, the data points are clearly out of a straight line of 1 in slant. These ions in the case of 0.5 μg can be interpreted to undergo an outstanding ion suppression. It is indicated that the deviation from the straight line is smaller than the decrease of the intensity of ions originated from the internal standard. This fact agrees with the interpretation that the decreasing rate of the ion intensity becomes equal to or less than that of ions originated from an internal standard.

In the case of performing the quantitation, ions for the detection are processed as a data set made by collecting the retention time and m/z (or m, or m and z) of the ions, the peak area or the ion intensity, and the error of the peak area or the ion intensity. Including not only errors in sample preparation and measurement errors in a mass spectrometer but also effects of the ion suppression and ion enhancement to the error of the peak area is considered to be important for the improvement in precision of results of data analysis. Alternatively, ions for the detection may be processed as a data set made by collecting the retention time and m/z (or m, or m and z) of the ions, the peak area or the ion intensity, and the presence/absence of the occurrence of quantitative analysis-inhibitory factors. In this case, by excluding the data in the retention time region where quantitative analysis-inhibitory factors have occurred from the analysis, the precision of results of data analysis can be expected to be held.

If a data set as described above is used, in comparison of a plurality of samples, peak areas or ion intensities in data sets with respect to ions in which the retention times and m/z (or m and z) are each consistent can be compared and analyzed. Then, by taking into consideration errors of peak areas or ion intensities included in data sets, it becomes possible to analyze the presence/absence and the degree of the variations with high precision.

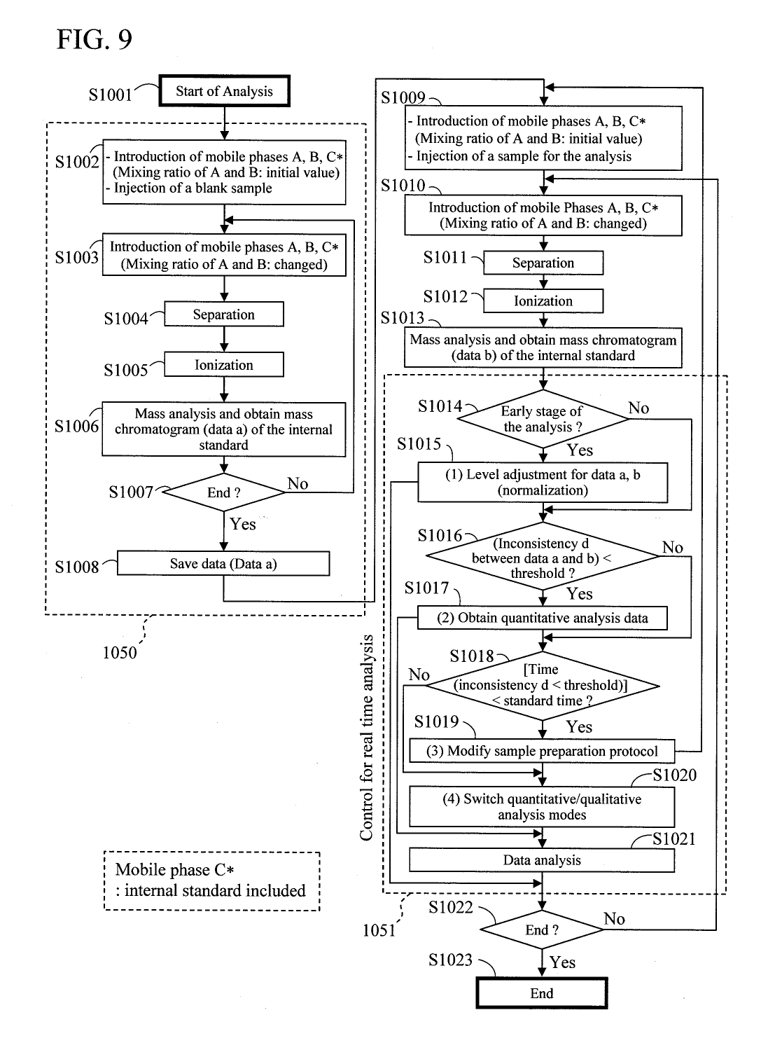

FIG. 3 shows an example of displayed data in the display unit of the data analysis unit. The flow of analysis steps in the Present Example is shown in FIG. 9, and hereinafter, the analysis steps will be described in detail using FIG. 3 and FIG. 9. FIG. 9 shows unit steps to analyze a test specimen of either of a disease subject or a healthy subject. Variant components having remarkable differences between the both may have been extracted before the analysis of FIG. 9, and the variant components only may be analyzed, or variant components may not be yet specified, and each test specimen may be analyzed through the steps of FIG. 9 for the purpose of analyzing all of constituting elements.

FIG. 3 is examples of the ion intensity 1201b (data b, black solid line) of ions originated from an internal standard when a trypsin enzyme digestive product of BSA (bovine serum albumin) was analyzed as a sample for the analysis, and the ion intensity 1201a (data a, gray solid line) of ions originated from the internal standard when a blank sample was analyzed. As the internal standard, a synthetic peptide whose amino acid sequence was SSSSSSK was used as in FIG. 2. As shown in FIG. 9, after the start of analysis (S1001), first, mobile phases A and B and a mobile phase C containing an internal standard are mixed in a predetermined ratio (initial value), and introduced from the mobile-phase introduction unit, and a blank sample is introduced from the sample introduction unit nearly at the same time (S1002). The analysis is started with the timing of the introduction of the blank sample set as time 0. Then, with the mixing ratio of the mobile phase C held at a constant, while the mixing ratio of the mobile phases A and B are varied in a predetermined variation amount in terms of time, the mobile phases A and B are introduced (S1003); the concentration of the internal standard is controlled so as to be always constant; and sequentially, the separation by LC (S1004), the ionization by the ionization unit (S1005), and the mass spectrometry by the mass-analysis unit are performed, and the ion intensity of ions originated from the internal standard, that is, data (data a) of a mass chromatogram is acquired (S1006). After the mixing ratio of the mobile phases is varied to a mixing ratio at the end over a predetermined time, and data for the analysis are obtained, the analysis is finished (S1007), and the data are saved in the data storage unit as data a (S1008). By the steps above, the mass chromatogram (data a) of the internal standard for reference acquired using the blank sample was acquired (1050).

Then, a sample for the analysis is introduced, and mass chromatogram data of ions originated from the internal standard is similarly acquired. First, as in acquiring data a, the mixing ratio of mobile phases A, B and C is set at the initial value, and those are introduced, and the sample for the analysis is introduced nearly at the same time (S1009). Then, with the mixing ratio of the mobile phase C fixed at a constant, the mixing ratio of the mobile phases A and B is varied in terms of time as in acquiring data a (S1010); and as in steps 1004 to 1006, sequentially, the separation (S1011) and the ionization (S1012) are performed, and the mass spectrometry of ions for the detection is performed to acquire data (data b) of a mass chromatogram of ions originated from the internal standards (S1013). At this analysis, while a real time analysis control is being performed (1051), data analysis is performed (S1021) as described later. By the steps of the above, the sample for the analysis is introduced, and the acquisition of the mass chromatogram of ions originated from the internal standard and the analysis of the sample are simultaneously performed (S1009 to S1023).

The electrospray ionization method (ESI) is used in the interface of LC/MS, but ion intensities for every analysis are not always consistent. Then, in the retention time region (the retention time region I in FIG. 3) right before components which are contained in the sample and are not separated are eluted, the ion intensity is normalized, that is, a level adjustment is made. In the time region III in the figure, it is indicated that the intensities of ions originated from the internal standard are nearly consistent, and no quantitative analysis-inhibitory factors occur in a broad range. By contrast, in the time region indicated as the time region IV in FIG. 3, ion intensities are not consistent. It can be interpreted that the occurrence of this inconsistency expresses the occurrence of quantitative analysis-inhibitory factors such as the ion suppression and a variation in the intensity of ions originated from the internal standard at the time of acquiring data b (that is, at the time of mixing the sample for the analysis). Data are processed such that the data are normalized and compared so as not to be influenced by high-frequency noise components and based on the average levels in each retention time. For example, high-frequency components of the data are eliminated, or otherwise, to extract low-frequency components, and data and data in the same retention time are compared and calculated. For example, in the normalization process, displaying is adjusted so that the magnitude of data a is set 100%, and data b becomes 100%±5%. This value, ±5%, is an example, and the value is saved in the control system 8 in advance as a range acceptable for normalization (level adjustment), or alternatively the system is configured such that an operator can input the value. Also in the comparison process, nearly similarly, data a is set 100%, and data b is calculated about how many percents the data b is to data a. For example, when data b is 97% to data a, it is judged that there is a difference of 3%. The numerical value (here, 3%) determined in such a way is hereinafter referred to as a difference ratio, and is defined as an index indicating the inconsistency between data a and b.

Seeing the data in detail, it is found that there is an error within several percents in data a and data b even in the time region III. The error of several percents is well known to be a dispersion in measurement of mass chromatograms by common LC/MS. Since there is an error of the ion intensity in such a mass chromatogram, it is necessary to judge that if a difference between data a and b is a minute deviation within several percents coming from the measurement error of a measurement apparatus, the deviation is accepted as a measurement dispersion; and if a difference between data a and b exceeds a threshold, the difference has occurred due to quantitative analysis-inhibitory factors. Then, a difference ratio (inconsistency) threshold to become a judgment criterion is determined in advance, and data are acquired and a difference ratio (inconsistency) is calculated to compare with the inconsistency threshold in real time. This inconsistency threshold is saved in the control system 8 in advance as in the normalization acceptable range as described above, or alternatively the system is configured such that an operator can input. In the present Example, since the measurement apparatus was assumed to exhibit an error in a regular level, so had a measurement error of about 5 to 10%, the difference ratio (inconsistency) threshold was set to be 15%. That is, the case where the difference ratio d between data a and b exceeded 15% was judged to be due to quantitative analysis-inhibitory factors. Such an error is considered to depend on mass spectrometers, and the system is so configured that errors according to the measurement apparatus can be input to the data analysis unit 105. In the data analysis unit 105 in FIG. 1, level adjustment means 114 to perform calculation and display control to perform the level adjustment between data a and b as described above, and calculation means 115 to calculate the inconsistency between data and to compare with the inconsistency threshold saved in advance are built in.

The inconsistency detected of the time region IV in FIG. 3 indicates the occurrence of quantitative analysis-inhibitory factors such as the ion suppression, and the precision of the data for the analysis of the sample decreases in the time region IV, so the quantitation is difficult. By contrast, the data in the time region III has a sufficient precision, so the quantitation is possible. Then, by extracting only the data of the sample for the analysis in the time region III, the quantitative analysis of the sample for the analysis in the time region III is performed. If the quantitative analysis of the sample for the analysis can be sufficiently performed in this time region III, the quantitation with a high reliability can be performed as it is. Thereby, even in the case where quantitative analysis-inhibitory factors occur during the analysis, data for a time region where the data is not influenced by inhibitory factors can be effectively utilized, and the waste of analysis can be eliminated. In the time region IV, since quantitative evaluation-inhibitory factors occur to decrease the precision of the quantitative evaluation result, and the data cannot be used, as described later, the analysis mode may be switched so as to preferentially perform the qualitative evaluation in the analysis real time in the time region IV. In the case where data cannot be acquired completely by one time of the analysis, the analysis of the above may be repeated.

In the case where the occurrence of such quantitative analysis-inhibitory factors such as the ion suppression is detected, by subjecting a sample to concentration reduction, refinement, separation and the like, the sample in which no quantitative analysis-inhibitory factors occur can be prepared. Also in this case, as a result of putting the sample under a feedback to reprepare the sample, unless an inconsistency is observed in a mass chromatogram of ions originated from the internal standard in the display unit of the data analysis unit, it can be confirmed that quantitative analysis-inhibitory factors come not to occur. Alterations of the preparation conditions of a sample are repeatedly performed, and if a time region where no quantitative analysis-inhibitory factors occur, or those occur but the quantitative analysis can be performed without being influenced by the occurrence is secured as a time region of a constant time length or longer, the alterations of the preparation conditions of the sample may be controlled to be stopped.

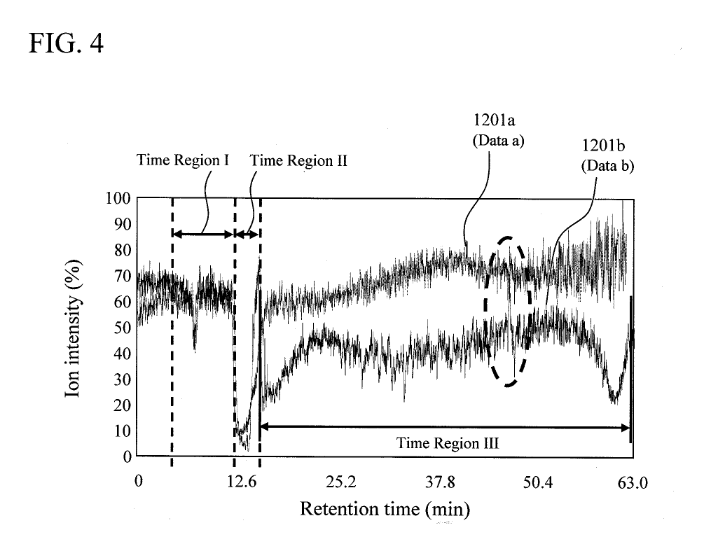

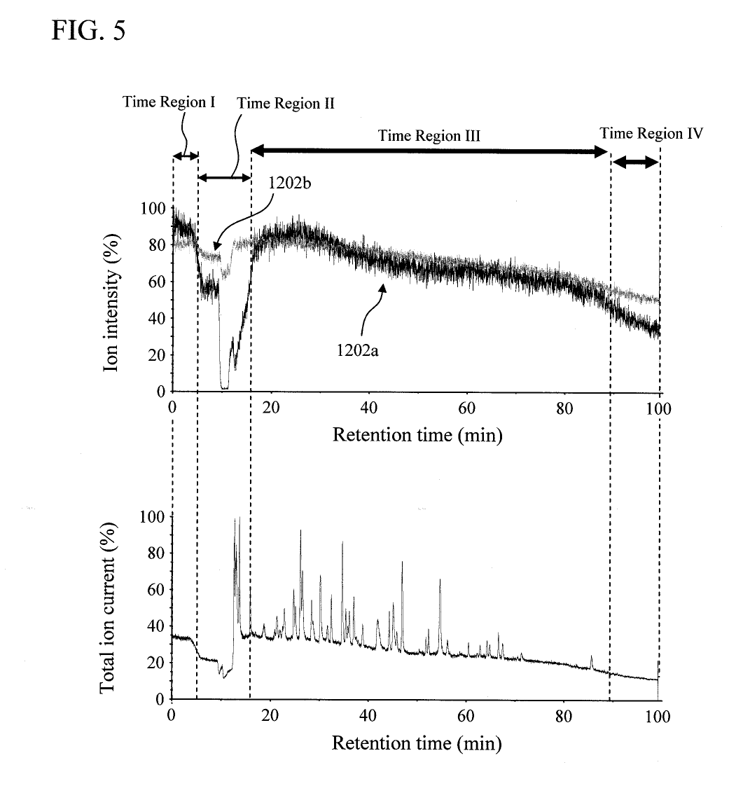

FIG. 4 shows an example in which quantitative analysis-inhibitory factors remarkably occur. In the present Example, it is indicated that the inconsistency in the ion intensities of ions originated from an internal standard occurs in a very broad region shown as the time region III in the figure and quantitative analysis-inhibitory factors occur, and that the data are unsuitable for the quantitation. This case needs to perform a reanalysis after performing countermeasures including: 1) the amount of a sample for the analysis is reduced to about 1/10; 2) separation and fractionation are performed in advance in the sample preparation; and 3) ionic impurities are removed by desalting or the like in the sample preparation. As described above depending on the inconsistency of ion intensities, effective quantitative data for the analysis cannot be acquired in some cases without countermeasures to the sample. The control system was configured such that a standard value is provided in advance in the times of the inconsistent region and the consistent region of ion intensities, and if the time of the consistent region of ion intensities is shorter than the standard time, the control system controls the successive repreparation of the sample. The standard time may be saved in the control unit 8 in advance, or may be input by an operator.

In the retention time region indicated as a dashed-line ellipse in FIG. 4, the intensity 1201b (data b) of ions originated from an internal standard in the data for the analysis of a sample increases, and becomes equal to that 1201a (data a) of a blank sample. However, examining mass spectra in this case, ions different from ions originated from the internal standard, but equal in m/z were detected. Therefore, also in this retention time region, no quantitative analysis-inhibitory factors cannot be said not to have occurred. As described herein, in the case of analyzing a very complicated sample, ions almost coincide in m/z with ions originated from an internal standard are observed in some cases, and this fact may adversely affect the detection of quantitative analysis-inhibitory factors. Then, mass chromatograms of ions originated from an internal standard are compared in the real time of the analysis, and if the inconsistency occurs, a tandem mass spectrometry such as MS/MS is conveniently performed. This is because by examining a relation between the ion intensity of ions originated from an internal standard and the intensity of dissociated ions detected by a tandem mass spectrometry in advance, and by acquiring tandem mass spectrometry spectra in real time, the intrinsic ion intensity of ions originated from the internal standard can be determined.

In the proteome analysis, the metabolome analysis and the marker search, since components contained in a sample are not always known, both of the qualitative (identification) analysis and the quantitative (variation) analysis are necessary. However, the qualitative (identification) analysis needs not only usual mass spectra, but also acquiring tandem mass spectrometry spectra such as MS/MS in a high throughput; and by contrast, the quantitative (variation) analysis does not perform the tandem mass spectrometry as far as possible, and needs acquiring usual mass spectra in a high throughput. That is, according to the purposes, the priority order of data acquired by a mass spectrometer is different.

Means was conventionally general in which for example, a qualitative analysis was first performed, and after all components were identified, a quantitative analysis was performed. Specifically, the qualitative analysis of all components was performed by the following process: a file to instruct the analysis procedure was stored in the control system 108 of an analyzer; when the qualitative analysis was performed, the control system 108 referred to the analysis procedure instruction file; and for example, the following processes were repeated: a usual mass spectrometry was performed once; thereafter, higher 10 peaks of a spectrum were extracted and tandem analyzed; a usual mass spectrometry was again performed to confirm the components; successively higher 10 peaks of the spectrum were again extracted and tandem analyzed. At this time, in the case where the types of components to be qualitatively analyzed were few, for example, only about 15 types, such a control was performed in some cases that after the qualitative analysis of all the components were completed by the second time of the tandem analysis, a quantitative analysis by a usual mass spectrometry was performed. This procedure was in some cases referred to as the qualitative analysis-preferential mode.

When the quantitative analysis was performed after such a qualitative analysis was completed, the control system 108 referred to another analysis procedure instruction file which had been stored in advance in the control system 108, and a usual mass spectrometry was performed to perform the quantitative analysis with high precision. That is, it was a general procedure that respective analysis procedure instruction files for the qualitative analysis and the quantitative analysis (first and second analysis procedure instruction files) were stored, and controls were performed according to these, and the analysis was performed in the order of the qualitative analysis→the quantitative analysis. However, since data acquisition for the qualitative (identification) analysis was performed in advance, and thereafter, data acquisition for the quantitative (variation) analysis was performed, an analysis with high throughput could not be performed in conformance with the conditions. By contrast, if there is a function to change analysis modes in real time, in the case of analyzing a sample containing multiple components, the function is advantageous from the viewpoint of making the throughput high.

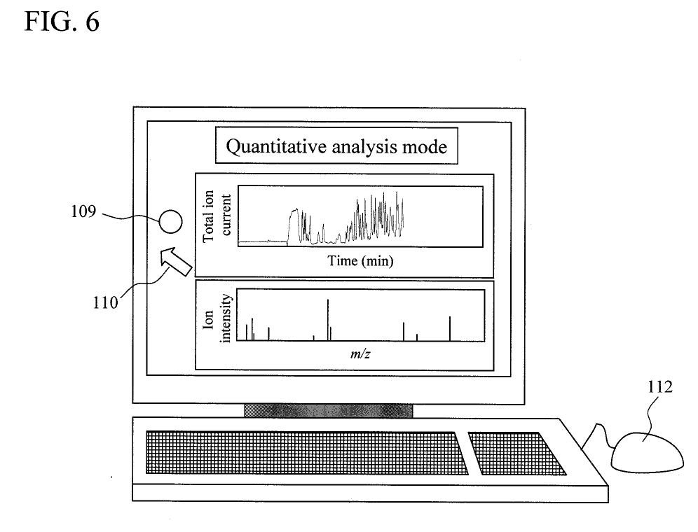

Then, as shown in FIG. 1 and FIG. 6, in the present invention, a comparison was made between mass chromatograms of ions originated from an internal standard in the real time of the analysis, and the control system was configured so that in the case where an inconsistency had occurred, the analysis mode was changed, for example, switched to the qualitative (identification) analysis-preferential mode. That is, the order of performing the qualitative/quantitative analyses is controlled in real time according to data to be acquired. In the present Example, for example, the analysis is performed in preference of the quantitative analysis (quantitative analysis-preferential mode). Then, the presence/absence of quantitative analysis-inhibitory factors are judged by the above-mentioned means, and in the time region where the analysis is not influenced by the inhibitory factors, the quantitative analysis is continued, and data for the analysis is stored in the control system 108. When the occurrence of inhibitory factors and the reveal of the influence are detected, the analysis mode is changed in preference of the qualitative analysis (qualitative analysis-preferential mode) because the precision of the quantitative analysis conceivably decreased. Thereby, even in the time region where the analysis was influenced by quantitative analysis-inhibitory factors, the qualitative analysis was allowed to be performed efficiently.

The above-mentioned quantitative analysis-preferential mode will be described further in detail. Conventionally, a control not to perform the qualitative analysis by the tandem was usually performed in the case of the quantitative analysis mode. By contrast, in the present Example, a control was performed so that the qualitative analysis could be anew performed even during the quantitative analysis depending on the characteristics of a spectrum. This is referred to as the quantitative analysis-preferential mode. For example, also in the time region where quantitative analysis-inhibitory factors are not detected, components to be presumed in advance to be present in a sample for the analysis are stored in the control system 108, and if a spectrum of a component to have not been presumed is acquired, the qualitative analysis may be performed during the quantitative analysis. Utilizing this function, a component analysis result of a sample for the analysis, for example, from a test specimen of a healthy subject is acquired and stored in the control system 108; and when a test specimen of a disease subject is analyzed, the result is referred to, and the analysis of only a component which has not been detected in the specimen from the healthy subject is switched to the qualitative analysis, thus enabling identification of the component. By controlling the analysis procedure in such a manner, the precision and the efficiency (that is, throughput) both have been remarkably improved in marker searches and the like.

In this case, the internal standard may be one type, or may be two types as described later. As described in the figure, the analyzer was configured so that the screen of the data analysis unit, or the screen of the control unit of the mass spectrometer displayed the state of the analysis as “quantitative analysis (preferential) mode”, “qualitative analysis (preferential) mode”, or the like in real time, and that an operator could confirm visually that the mass spectrometer operated normally. The mode switching may be controlled such that something like a third analysis procedure instruction file is stored in the control system 108, and “the qualitative analysis-preferential mode” and “the quantitative analysis-preferential mode” are switched based on data successively acquired, or may be performed by a constitution in which as shown in FIG. 6, the display unit has a mode selection button 109 of the qualitative/quantitative analyses, and an operator switches the modes with a pointer 110 by a pointing device 112 or the like according to needs while the operator monitors successively the analysis results. The judgment criterion to judge the switching may be stored in the control unit 8, or may be input by an operator.

As described hitherto, the control system for the control represented as real-time analysis control (1051) in FIG. 9 was configured to involve: (1) the normalization and level adjustment in real time of data a and data b in the analysis initial stage (S1014, S1015); (2) the judgment of the presence/absence of real-time quantitative analysis-inhibitory factors (the inconsistency between intensity data a and b of ions originated from an internal standard) (S1016) and the data extraction in an effective time region where no quantitative analysis-inhibitory factors occur by the result of the judgment (S1017); (3) the modification of conditions for separating and preparing samples, and the like (S1018, S1019), in the case where the degree of the influence of quantitative analysis-inhibitory factors (a length of time where data a and b are consistent, and the like) is large (the length of time of the consistency is equal to or smaller than a standard value); and (4) the switching and selection of the preferential mode of the quantitative/qualitative (tandem) analyses in the time region where the analysis is influenced by quantitative analysis-inhibitory factors (S1020) to perform the quantitative and qualitative analyses by analyzing data acquired (S1021). Further for example, also in the quantitative analysis-preferential mode, in the case where an outstanding characteristic was found in the spectrum, for example, a peak of a component not expected was detected as compared with an expected component of a sample for the analysis stored in advance, the analysis mode was controlled in real time to perform the qualitative analysis. In the case where an analysis is finished and data for the analysis have not been acquired completely, the analysis is repeated to acquire all data required.

In the data analysis unit 105, means 116 to detect a time region where the inconsistency is smaller or larger than a threshold of the inconsistency, and means 117 to collect data for the analysis in a time region where the inconsistency is small, that is, the consistency is large (time region of consistency) are built in. The data analysis unit has a constitution having a storage unit for the above-mentioned analysis procedure instruction file, and a control unit to read the file.

### EXAMPLE 2

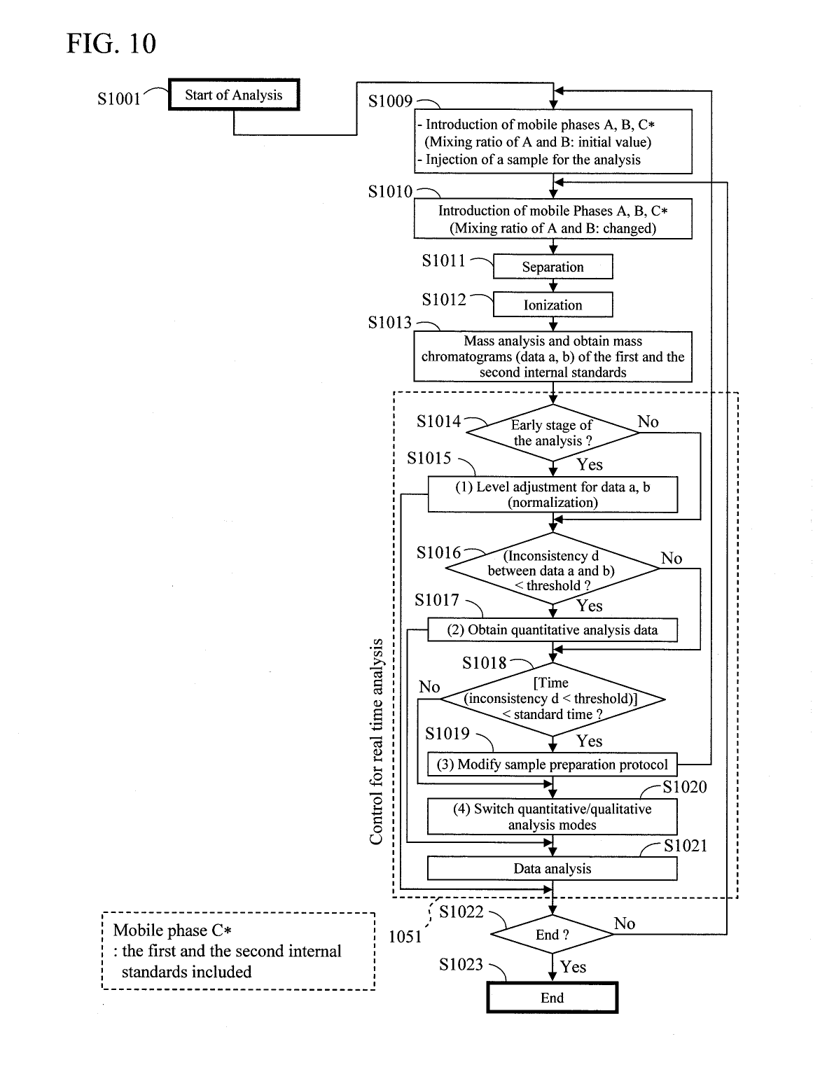

Next, as Second Example, analysis means using two types of internal standards will be described using FIG. 5 and FIG. 10. As shown in FIG. 10, use of two types of internal standards does not allow for evaluation by performing two times of analyses as in Example 1, but allows for evaluation of the presence/absence of the occurrence of quantitative analysis-inhibitory factors by one time of the analysis. Thereby, the analysis time can be further reduced. The two types of internal standards are selected such that these are substances to be always detected as ions, that is, hydrophilic substances; and one of them is acidic, and the other thereof is basic; and the former sensitively changes to quantitative analysis-inhibitory factors, and the latter hardly changes.

That is, one of the internal standards to be selected has an isoelectric point of about 3 or more and 8 or less; and the other thereof has that nearly equal to or more than 8. Here, a substance having a high hydrophilicity and a high acidity is denoted as a first internal standard; and a substance having a high hydrophilicity and a high basicity is denoted as a second internal standard. The upper part of FIG. 5 shows a mass chromatogram (1202a, black solid line) of ions originated from the first internal standard, and a mass chromatogram (1202b, gray dashed line) of ions originated from the second internal standard obtained in the present Example. In the present Example, in the time region I in FIG. 5, the level adjustment of the intensities and the normalization of the intensities of ions originated from the first and second internal standards are performed in real time, and the ion intensities are overlappingly displayed in the display unit of the data analysis unit. In analysis by LC/MS, there was a possibility of causing an unexpected subtle variation in the ion amount caused by the analyzer, but in the case of performing the analyses two times as in Example 1, since random variations may occur every time, the influence of the unexpected random variations in the ion amount cannot be avoided. However, in the present Example, since two data can simultaneously be acquired and compared, even when an unexpected variation in the ion amount is caused due to the analyzer, similar variations occur in the both data and the difference between the both ends in not being affected by the ion variation. Consequently, the present Example has an advantage in which the evaluation of the inconsistency can be performed more precisely and accurately than Example 1.

The lower part of FIG. 5 is a total ion chromatogram, and data for the analysis in the retention time region (time region III) different from the retention time (time region IV) when quantitative analysis-inhibitory factors occur can be subjected to the quantitation. Then, only the data for the analysis in the retention time region (time region III) is extracted, and stored in the data analysis unit or the like under another name. In such a manner, only data for the analysis allowing to be subjected to the quantitation can be analyzed. As described above, the present Example is different from First Example in the point that while the presence/absence of the occurrence of quantitative analysis-inhibitory factors is being judged by one time of the analysis using two types of internal standards, the target sample for the analysis is analyzed; and other points are the same as in First Example. That is, the inconsistency between two internal standards is calculated from mass chromatograms thereof as in First Example; the inconsistency is compared with a threshold of the inconsistency determined in advance; an analysis time region where the inconsistency is smaller than the threshold is detected; and data for the analysis in this analysis time region is collected. The two internal standards are injected in a constant concentration to a mobile phase, and the analysis is configured so that these can be detected stably over the whole analysis time.

As in First Example, in the case where the inconsistency between the two mass chromatograms are large, the quantitative/qualitative-analysis preferential modes are switched and are put in preference of the qualitative analysis (tandem analysis), and the switching situations are displayed; and in the case where the length of the time region when the inconsistency becomes sufficiently small is shorter than the standard time determined in advance, the preparation condition of the sample is modified and a control is performed so as to repeat the preparations until the inconsistency becomes small to achieve the analysis with high efficiency and high precision. The constitution of the analyzer used in Second Example is nearly the same as that used in First Example shown in FIG. 1, except that details of calculation contents of the data analysis unit 105 and calculation means in the control unit 8 are partially different.

### EXAMPLE 3

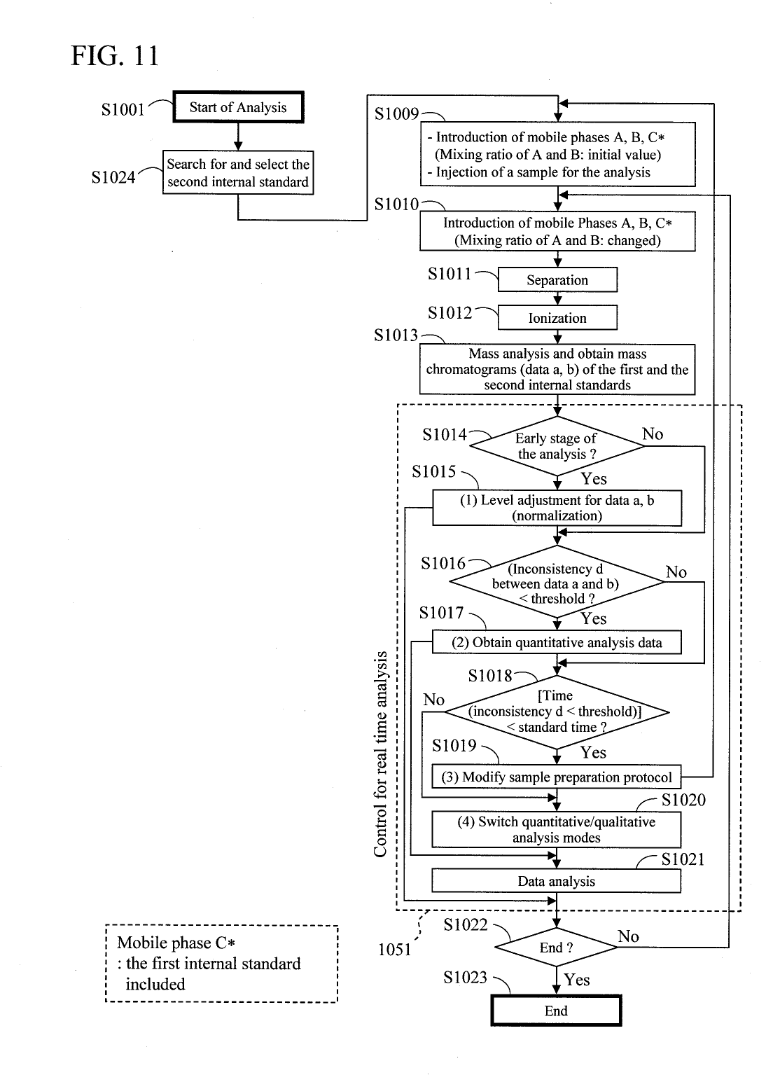

As Third Example, means will be described in which one type of an internal standard is introduced and denoted as a first internal standard; and a second internal standard is not positively introduced, and a component capable of becoming a second internal standard is searched from component substances such as impurities unintentionally mixed; and mass chromatograms of the both are simultaneously compared. The analysis steps of the present Example, as shown in FIG. 11, has a step (S1024) of searching and selecting a substance usable as a second internal standard, the step being added as compared to Second Example in FIG. 10. In this case, the first internal standard to be selected is, as in the first internal standard in Second Example, a hydrophilic and acidic substance, and the substance sensitively reacting to quantitative analysis-inhibitory factors.

A search monitor for the second internal standard is provided; and a substance which is present in the analyzer and stably detected as ions in a broad retention time region, and additionally little influenced by quantitative analysis-inhibitory factors is detected by changing mobile phases and samples. For example, ions of a type of impurities such as siloxane were observed stably in a broad retention time region, and additionally little varied in the ion intensity to quantitative analysis-inhibitory factors such as the ion suppression. Such a substance is selected as the second internal standard; and mass chromatograms of the first and second internal standards are simultaneously acquired and compared as in Second Example to detect the quantitative analysis-inhibitory factors. Other parts of the procedure are the same as in First and Second Examples. The analyzer of the present Example has, as compared with the analyzer constitution of First Example, a constitution further concurrently having monitoring means to monitor data for the analysis of a plurality of substances in order to search a substance capable of becoming a second internal standard, and an input unit to select and input the searched and found substance as the second internal standard, that is, an input device such as a pointing device or a key board, a selection menu and a selection button, a display menu such as a numerical value input column, and the like.

### EXAMPLE 4

Then, as Fourth Example, means will be described in which a type of an internal standard is introduced; and quantitative analysis-inhibitory factors are detected by only the analysis result by introduction of a sample for the analysis without an analysis of a blank sample. As shown in FIG. 2, the mass chromatogram of the internal standard has a tendency of not rapidly varying in terms of time. Hence, without using an analysis result of a blank sample, it is possible in principle to detect the occurrence of quantitative analysis-inhibitory factors. Then, only in the condition that the sample for the analysis is introduced, by the acquisition of a mass chromatogram of ions originated from the internal standard, and the examination of whether or not there is a rapid change in terms of time therein, the quantitative analysis-inhibitory factors are detected. This analysis means, in the case where the decrease in the intensity of ions originated from the internal standard due to analysis-inhibitory factors is not rapid, needs to be paid attention to in the point that it becomes difficult to detect the occurrence of the analysis-inhibitory factors.

### EXAMPLE 5

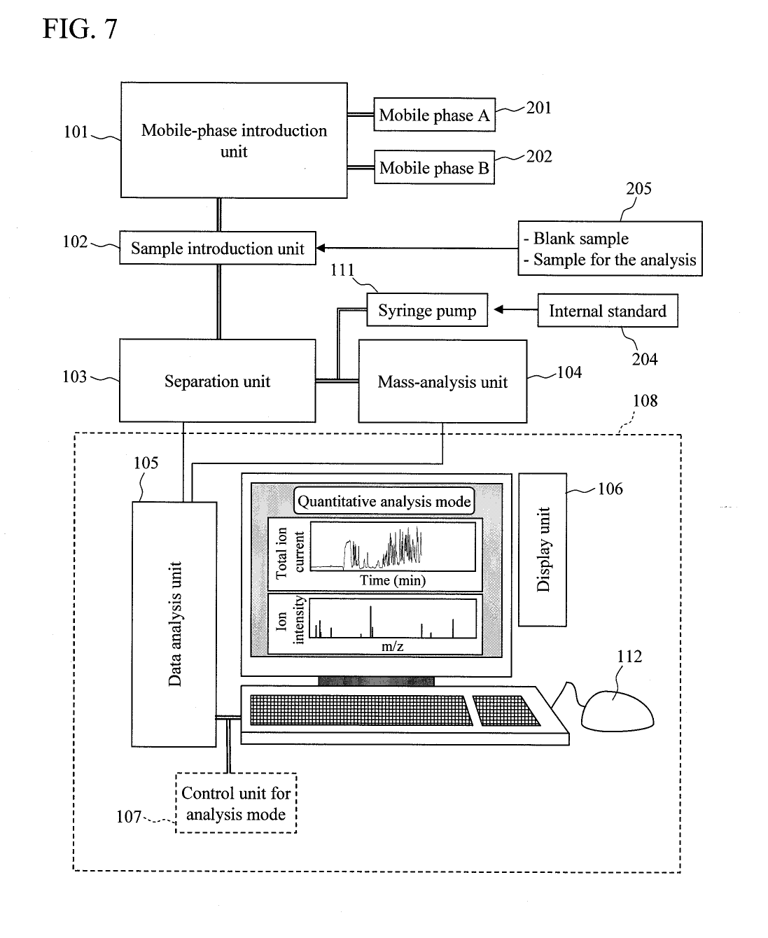

In a constitution diagram of another example in a mass spectrometry system according to the present invention shown in FIG. 7, unlike the example of FIG. 1, an internal standard 204 is injected to the downstream of the separation unit 103 from a syringe pump 111. Thereby, the internal standard 204 is mixed with an eluate of the liquid chromatograph in a constant ratio. Of course, it suffices if the internal standard 204 can be mixed with a liquid for the analysis, and the mixing place may be anywhere as long as the upstream side of the interface (ion source). In the case of using a conventional liquid chromatograph, a semi-micro liquid chromatograph and a micro liquid chromatograph, whose flow rates are higher than 1 microliter/min, such a constitution is more advantageous than the constitution shown in FIG. 1. This is because the exchange of a solution containing the internal standard is easy. The present Example can be performed in combination with First to Fourth Examples.

### EXAMPLE 6

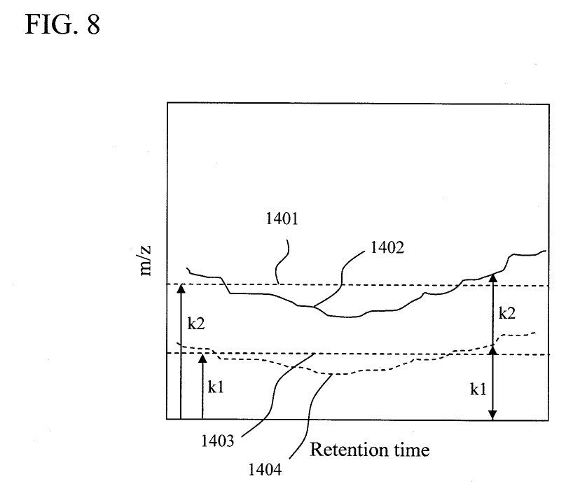

FIG. 8 shows a retention time dependency of a mass shift utilizing the detection of ions originated from the internal standard in another example of a mass spectrometry system according to the present invention. If the analysis using a liquid chromatograph takes several or more minutes, the precision in mass in a ppm level decreases due to the temperature change and the like in some cases. Then, by examining the measurement value (1402 in FIG. 8) of m/z of ions originated from an internal standard having a known calculated mass (1401 in FIG. 8) with respect to the retention time, the measurement value (1404 in FIG. 8) of m/z of ions detected at each retention time can be corrected by the proportional distribution (1403 in FIG. 8). Hence, particularly in the data base retrieval in the qualitative analysis, the identification of a substance can be performed with very high precision. The present Example can be performed in combination with First to Fifth Examples.

Hitherto, means to detect quantitative analysis-inhibitory factors for the field of marker searches mainly for disease diagnoses, and mass spectrometry systems utilizing the means have been described. On the other hand, in the field such as pharmacokinetics using a tandem mass spectrometry referred to as Multiple Reaction Monitoring: MRM, the tandem mass spectrometry is used not only for the qualitative analysis for a substance but also for the quantitative analysis. Such a case needs that a tandem mass spectrometry of ions originated from an internal standard is performed in advance, and m/z of one type or several types of major fragment ions are registered in a mass spectrometer. Thereby, a mass chromatogram of major fragments of ions originated from an internal standard can be acquired. Then, in the mass chromatogram of the fragment ions, the occurrence of quantitative analysis-inhibitory factors can be detected by the variation (decrease) of the intensity. The specific method for the detection and the like are the same as those described hitherto.

### EXAMPLE 7

The technology according to the present invention can be applied to automatic analyzers and diagnosing apparatuses to examine the concentrations and the amounts of drugs and the like in blood and urine. Then, hereinafter, particularly an example of a constitution and steps of an automatic analyzer using the solid-phase extraction method will be described. In the sample preparation for an automatic analyzer and a diagnosing apparatus, a different method may be used other than a solid-phase extraction method and a method for introducing a sample to the mass analysis unit described in the present Example, but the effect can be exhibited similarly.

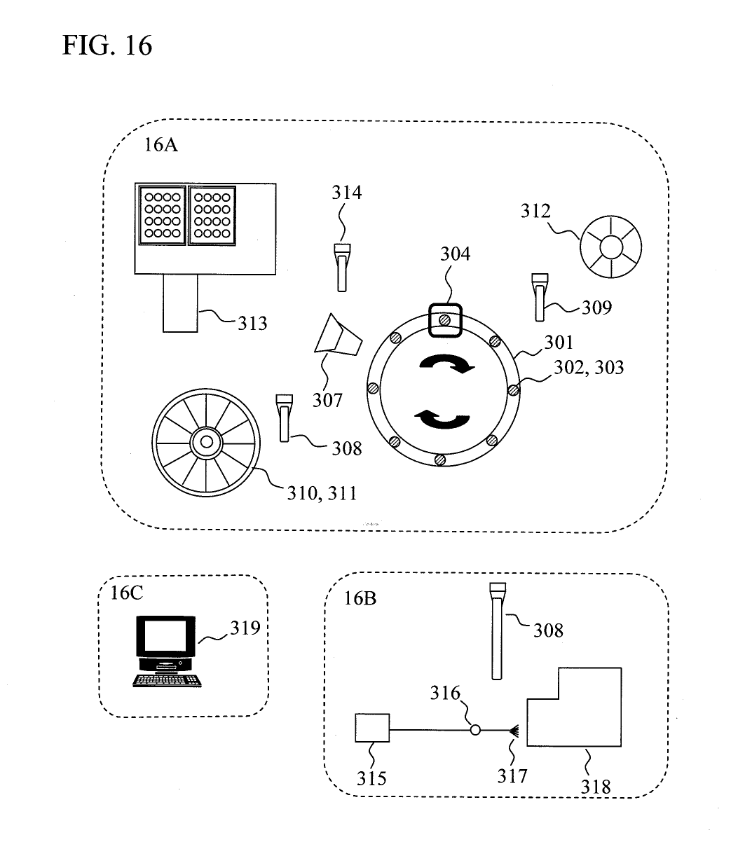

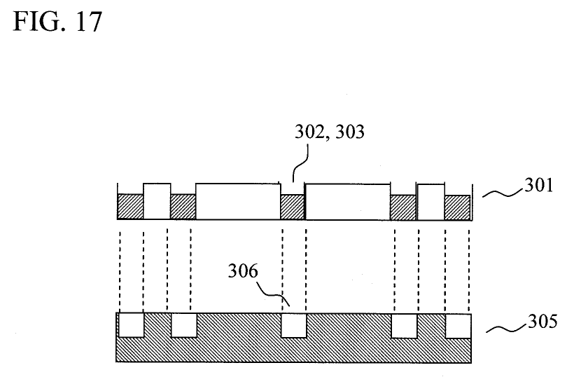

An automatic analyzer in the present Example is, as shown in FIG. 16 and FIG. 17, constituted of a solid-phase extraction unit (16A), a detection unit (16B), and a control unit (16C). In the example, a storage unit is contained in the control unit.

The solid-phase extraction unit (16A) is equipped with a turn table 301 on which cartridge-holding containers 303 to hold disposable solid-phase extraction cartridges 302 are disposed, a cartridge storage unit 312 to store the solid-phase extraction cartridges 302, a rotary arm 309 to move the solid-phase extraction cartridges 302 from the cartridge storage unit 312 to the cartridge-holding containers 303, a turn table-type reagent tank 310 in which reagent containers 311 are disposed, a rotary arm 308 to transport reagents from the reagent containers 311 to the solid-phase extraction cartridges 302, a pressure loading unit 304 to perform the extraction step by loading a pressure on at least one solid-phase extraction cartridge 302, a turn table 305 on which a plurality of receiving containers 306 to receive solutions extracted from the solid-phase extraction cartridges 302 is disposed under the turn table 301, the rotary arm 308 to transport the extracted solutions from the receiving containers 306 to a sample introduction unit 316, and a liquid surface sensor 307 to detect the degree of progress of the extraction.

The solid-phase extraction cartridge 302 is equipped with a pressure releasing valve to operate to release the pressure, and the constitution is such that the pressure releasing valve is released when the liquid surface detected by the liquid surface sensor reaches the liquid surface position previously set.

The detection unit (16B) is equipped with a pump 315 to extrude the solution in order to introduce a sample to an ionization unit, the ionization unit 317 to ionize the sample by impressing a voltage, a sample introduction unit 316 located at the post-stage of the pump 315 and the pre-stage of the ionization unit 317 and to introduce the sample into a flow passage, and a mass-analysis unit 318 to analyze/examine the ionized sample.

The control unit (16C) is composed of a control unit 319 to control automatically and collectively each unit constituting the analyzer.

Hereinafter, the examination/analysis of the analyzer including solid-phase extraction operation will be described in the order of steps.

### Standard Reagent Addition Step

A standard reagent in a constant concentration is added to a sample transported by the sample transportation unit 313. The addition is performed such that the standard reagent in the reagent container 311 in the reagent tank 310 is sucked by the rotary arm 308, and the reagent is added to the sample transportation unit 313. As the standard reagent, desirable is use of a stable isotope-labeled molecule obtained by substituting hydrogen (H) or carbon (C) of drugs or the like being an object of the examination/analysis contained in the sample with ²H or ¹³C. However, in the case where availability of the stable isotope-labeled molecule is difficult, a chemical analog whose chemical structure is partially different from the object substance for the analysis (drug or the like) is used. Although it is desirable that the chemical analog is the same as the object substance for the analysis in physicochemical properties as is the case with the stable isotope-labeled molecule, there is no guarantee therefor. The ends of the rotary arms 308, 309 and 314 are each equipped with a pipette or a syringe to suck/discharge the reagent, and with a mechanism to automatically cleaning the end after suction discharge of the reagent.

### Attachment and Detachment of the Solid-Phase Extraction Cartridge 302

The cartridge storage unit 312 is arranged in the turn table 301 with the same angles from the center; and the solid-phase extraction cartridges 302 are replaceable, and successively transported by the rotary arm 309 and installed in the cartridge-holding containers 303. The solid-phase extraction cartridges 302 are installed in the cartridge-holding containers 303 by transport means such as a belt conveyer in some cases.

### Cleaning Step of the Solid-Phase Extraction Cartridge 302

Then, the solid-phase extraction cartridge 302 is cleaned. The cleaning step is such that the turn table 301 rotates to the operational range of the rotary arm 308; a reagent for cleaning in the reagent container 311 in the reagent tank 310 is sucked by the rotary arm 308; and the reagent for cleaning is injected to the solid-phase extraction cartridge 302. Then, the turn table 301 rotates to the operational range of the pressure loading unit 304; and a pressure is loaded to move the reagent for cleaning from the upper part to the lower part of the solid-phase extraction cartridge 302 to perform the cleaning step. As shown in FIG. 17, the turn table 305 having the same shape as the turn table 301 is arranged vertically under the turn table 301; in the case where a component for the extraction is necessary to be captured, the receiving container 306 is arranged vertically under the cartridge-holding container 303 to capture the component for the extraction, by the rotary angles of the turn table 301 and the turn table 305. In the case where there is no need for the capture of the component for the extraction, the eluted component is disposed of as a waste liquid. The turn table 301 and the turn table 305 have a mechanism capable of rotating them to the clockwise rotary direction and the anticlockwise rotary direction, and can rotate to the direction in which they can move to the next operational position in a short time.

In the cartridge-holding container 303 of the turn table 301, the plurality of solid-phase extraction cartridges 302 is arranged; and the suction and injection operations of the reagent, and the loading operation of a pressure can be simultaneously performed for each solid-phase extraction cartridge 302.

With respect to the relation between the shape of the turn table 301 and the positions of the cartridge-holding containers 303, the cartridge-holding containers 303 are positioned evenly with the same angles from the center of the circular turn table 301.

The relation between the shapes and the positions of the cartridge-holding containers 303 arranged on the turn table 301 and the receiving containers 306 arranged on the turn table 305 can assume the following structures. That is, the turn table 301 and the turn table 305 have the same shape; and the cartridge-holding containers 303 and the receiving containers 306 correspond to each other one to one in the vertical directions. Alternatively, the turn table 301 and the turn table 305 have the same shape; but the cartridge-holding containers 303 and the receiving containers 306 do not correspond to each other one to one, and the shape may be such that one cartridge-holding container 303 has a plurality of receiving containers 306. Further alternatively, the turn table 301 and the turn table 305 have different shapes, for example, an elliptic shape or a linear shape, and the shape may be such that one cartridge-holding container 303 has a plurality of receiving containers 306 according to the different shapes.

### Equilibration Step to the Solid-Phase Extraction Cartridge 302

The solid-phase extraction cartridge 302 once cleaned with an organic solvent is subjected to the equilibration so that a drug component in the sample becomes in the state capable of being adsorbed in the solid-phase extraction cartridge 302. The equilibration step is such that the reagent tank 310 rotates to the operational range of the rotary arm 308; and a reagent for the equilibration in the reagent container 311 is sucked and discharged by the rotary arm 308, and injected into the solid-phase cartridge 302. Then, the turn table 301 rotates to the operational range of the pressure loading unit 304; and a pressure is loaded to move the reagent for the equilibration from the upper part to the lower part of the solid-phase extraction cartridge 302, thereby performing the equilibration step. The reagent for the equilibration to be used is usually an aqueous solution.

### Adsorption Step to the Solid-Phase Extraction Cartridge 302

A sample to which a standard reagent in a constant concentration has been added is injected to the solid-phase extraction cartridge 302 having being subjected to the equilibration to adsorb the drug component in the sample. The adsorption step is such that the sample transportation unit 313 rotates to the operational range of the rotary arm 314; and the sample on the sample transportation unit 313 is sucked/discharged by the rotary arm 314, and injected to the solid-phase cartridge 302. Then, the turn table 301 rotates to the operational range of the pressure loading unit 304; and a pressure is loaded to move the reagent for the equilibration from the upper part to the lower part of the solid-phase extraction cartridge 302, thereby performing the adsorption step.

### Cleaning Step

By performing the cleaning step, nonspecifically adsorbed components among components adsorbed on the solid-phase extraction cartridge 302 in the adsorption step leave the solid-phase extraction cartridge 302, thereby concentrating the target drug component. The cleaning step is such that the reagent tank 310 rotates to the operational range of the rotary arm 308; and a reagent for cleaning in the reagent container 311 is sucked/discharged by the rotary arm 308, and injected to the solid-phase cartridge 302. Then, the turn table 301 rotates to the operational range of the pressure loading unit 304; and a pressure is loaded to move the reagent for cleaning from the upper part to the lower part of the solid-phase extraction cartridge 302, thereby performing the cleaning step. The reagent for cleaning to be used is usually a solution containing mainly an organic solvent such as methanol or acetonitrile.

### Elution Step

The drug component adsorbed on the solid-phase extraction cartridge 302 is eluted. The elution step is such that a reagent for the elution is injected to the solid-phase extraction cartridge 302 as in the cleaning step; and a pressure is loaded to move the reagent for the elution from the upper part to the lower part of the solid-phase extraction cartridge 302, thereby performing the elution step. The reagent for the elution contains an internal standard in a constant concentration, and as a solvent, an organic solvent such as methanol or acetonitrile is used.

### Introduction to the Detection Unit

The eluted solution is introduced to the detection unit (16B) to perform the examination/analysis. The introduction to the detection unit (16B) is made such that the turn table 305 rotates to the operational range of the rotary arm 308, and the eluted solution is sucked/discharged from the receiving container 306, and introduced to the sample introduction unit 316. In the ionization unit 317, the ionization is performed by the electrospray ionization method (ESI) or an atmospheric pressure chemical ionization method (APCI). For the ionization unit, the matrix assisted laser desorption ionization method (MALDI) also is conceivable which performs the ionization by a MALDI plate and the irradiation of a laser light.

The object substance for the analysis, its standard reagent (stable isotope-labeled molecule or a chemical analog) and the internal standard ionized in the ionization unit are subjected to the mass separation and the detection by the mass-analysis unit 318. Then, the intensities of ions originated from them are determined, respectively.

### Evaluation of Acquired Data in the Control Unit

If the intensity of ions originated from the internal standard is consistent with that of the blank sample within the threshold range, no ion suppression is confirmed to have occurred. In this case, in the control unit, the concentration and amount of the object substance for the analysis can be determined and output using a calibration curve from the intensity of ions originated from the object substance for the analysis, based on the intensity of ions originated from the standard reagent.

On the other hand, unless the intensity of ions originated from the internal standard is consistent with that of the blank sample within the threshold, the ion suppression is confirmed to have occurred. Although the quantitation has no problem in the case where the standard regent is a stable isotope-labeled molecule, in the case where the standard reagent is a chemical analog, it is desirable that the pretreatment condition and the like are partially changed and the reanalysis is performed. An example of changing the pretreatment condition conceivably involves an increase in the amount of the reagent for cleaning to be injected to the solid-phase extraction cartridge in the cleaning step. As a result of the reanalysis, if the intensity of ions originated from the internal standard is consistent with that of the blank sample within the threshold, the concentration and amount of the object substance for the analysis can be determined and output from the intensity of ions originated from the object substance for the analysis, based on the intensity of ions originated from the standard reagent. Unless the intensity of ions originated from the internal standard is consistent with that of the blank sample within the threshold, the pretreatment condition is further changed partially, and the reanalysis is performed. Performing such a reanalysis results in a temporarily decreased analysis throughput. However, unless reanalyses frequently occur, there is no problem in practical use. In the information of the data acquired in the reanalysis, the information on changed analysis conditions is desirably contained. In the analysis condition to be changed, a calibration curve is desirably obtained in advance.

In the case where the standard reagent is a chemical analog and the execution of the reanalysis as described above is difficult, it is practical that the concentration and amount of the object substance for the analysis are presumed (corrected) and output from the intensity of ions originated from the object substance for the analysis, based on the intensity of ions originated from the standard reagent. The presumption conceivably includes a method in which the occurrence of the ion suppression is taken into account, and other various methods. However, since in the decreasing rate of the ion intensity caused by the occurrence of the ion suppression, a difference can be caused between the object substances for the analysis and the chemical analog, the presumed value is significantly different from a true value in some cases. Then, it is considered to be effective that an error reflecting the decreasing rate of ions originated from the internal standard is imparted to the presumed value.

Hereinafter, a simple presumption example will be considered. That is, the decreasing rate of ions originated from a chemical analog caused by the occurrence of the ion suppression is denoted as T [%]; the intensity of ions originated from the chemical analog is converted to 100/(100−T) times; and the concentration and amount of the object substance for the analysis is presumed from the ratio of the converted ion intensity and the intensity of ions originated from the object substance for the analysis. At this time, there is a possibility that ions originated from the object substance for the analysis are not at all influenced by the ion suppression, whereas there is also a possibility that the ion intensity is decreased as largely as ions originated from the internal standard. That is, if the decreasing rate of ions originated from the internal standard is denoted as Tₚ [%], there is a possibility that a presumed value is corrected excessively by T [%], whereas there is also a possibility that the correction is insufficient by 100{1−(100−Tₚ)/(100−T)}[%]. Then, by reflecting these to the error information of the presumed value, the difference from a true value can be expressed. Thus, to impart the error information based on the decreasing rate of the intensity of ions originated from a chemical analog and the decreasing rate of ions originated from an internal standard to the error information of the presumed value connects directly with the maintenance of a high reliability in data obtained by automatic analyzers and diagnosing apparatuses. Of course, as the presumption method of the intensity of ions originated from an object substance for the analysis based on the intensity of ions originated from a chemical analog, another method may be employed. It is important that the error information based on the decreasing rate of the intensity of ions originated from a chemical analog and the decreasing rate of ions originated from an internal standard is reflected to the error information of a presumed value.

### EXAMPLE 8

In automatic analyzers and diagnosing apparatuses to examine the concentrations and amounts of drugs and the like in blood and urine, a method for preparing samples without using the solid-phase extraction method can be employed. For example, a solution for the analysis is diluted to such a degree that no ion suppression is expected to occur, and a high-efficient ionization is performed at a low flow rate of several nano-liters/min by the electrospray ionization method (nanoelectrospray ionization method), which is effective. Hereinafter, an example of the analysis procedure will be described.

First, only a dilute solution containing an internal standard and a standard reagent in constant concentrations are filled in a chip for a nano-spray whose tip end is in a micron size, to make a blank sample for the analysis. Thereby, a reference data is acquired. Then, a solution for the analysis is diluted with the diluted solution described above, and filled in a chip for another nano-spray, and analyzed. The result is compared with the reference data, and if the ion intensity of ions originated from the internal standard is consistent within the threshold range, no occurrence of the ion suppression is confirmed. In this case, the concentration and amount of the object substance for the analysis can be determined from the ratio of the intensities of ions originated from the object substance for the analysis to ions originated from the standard reagent. By contrast, unless the ion intensity of ions originated from the internal standard is consistent within the threshold range, the inconsistency can be reflected to the error of the measurement value. However, in order to obtain measurement values with high precision, a remeasurement needs to be performed by increasing the dilution magnification of the solution for the analysis. Such a remeasurement is desirably automatically performed in the analyzers and the diagnosing apparatus.

All of publications, patents, and patent applications referred to in the present description are incorporated into the present description as they are herein by standard.

1. A method of an analysis using a liquid chromatograph/mass spectrometer, comprising the steps of:
mixing a standard molecule in a solution for the analysis;
acquiring a first mass chromatogram of ions originated from the standard molecule in a condition that mixing of a sample for the analysis in the solution for the analysis is negligible;
acquiring a second mass chromatogram of ions originated from the standard molecule in a condition that the sample for the analysis is mixed in the solution for the analysis;
performing a level adjustment of the first and the second mass chromatograms;
calculating an inconsistency between the first and the second mass chromatograms, and comparing the inconsistency with a threshold of an inconsistency stored in advance;
detecting a time region for the analysis in a condition that the inconsistency is smaller than the threshold of an inconsistency; and
collecting data for the analysis of the sample for the analysis acquired in the time region for the analysis,
wherein a height of hydrophobicity of the standard molecule mixed in the solution for the analysis is changed according to a ratio of an organic solvent in a mobile phase of the liquid chromatograph.

2. The method of an analysis according to claim 1, wherein the standard molecule is hydrophilic in the case where a ratio of the organic solvent in the mobile phase is 50% or less.

3. The method of an analysis according to claim 1, wherein the standard molecule is hydrophobic in the case where a ratio of the organic solvent in the mobile phase is 70% or more.

4. The method of an analysis according to claim 1, wherein the standard molecule has an isoelectric point or a dissociation constant of approximately 2 or more and 8 or less.

5. The method of an analysis according to claim 1, wherein the standard molecule has an isoelectric point or a dissociation constant of approximately 8 or more.

6. A method of an analysis using a liquid chromatograph/mass spectrometer, comprising the steps of:
mixing a standard molecule having an isoelectric point or a dissociation constant of approximately 2 or more and 8 or less and a standard molecule having that of 8 or more in a solution for the analysis;
acquiring a first mass chromatogram of ions originated from the standard molecules in a condition that mixing of a sample for the analysis in the solution for the analysis is negligible;
acquiring a second mass chromatogram of ions originated from the standard molecules in a condition that the sample for the analysis is mixed in the solution for the analysis;
performing a level adjustment of the first and the second mass chromatograms;
calculating an inconsistency between the first and the second mass chromatograms, and comparing the inconsistency with a threshold of an inconsistency stored in advance;
detecting a time region for the analysis in a condition that the inconsistency is smaller than the threshold of an inconsistency; and
collecting data for the analysis of the sample for the analysis acquired in the time region for the analysis,
wherein a positive ion detection mode and a negative ion detection mode is switched in one time of liquid chromatograph/mass spectrometry.

7. A method of an analysis using a liquid chromatograph/mass spectrometer, comprising the steps of:
mixing a hydrophilic standard molecule and a hydrophobic standard molecule in a solution for the analysis;
acquiring a first mass chromatogram of ions originated from the hydrophilic and the hydrophobic standard molecules in a condition that mixing of a sample for the analysis in the solution for the analysis is negligible;
acquiring a second mass chromatogram of ions originated from the hydrophilic and the hydrophobic standard molecules in a condition that the sample for the analysis is mixed in the solution for the analysis;
performing a level adjustment of the first mass chromatogram and the second mass chromatogram of ions originated from the hydrophilic standard molecule and the hydrophobic standard molecule;
calculating an inconsistency between the first and the second mass chromatograms, and comparing the inconsistency with a threshold of an inconsistency stored in advance;
detecting a time region for the analysis in a condition that the inconsistency is smaller than the threshold of an inconsistency; and
collecting data for the analysis of the sample for the analysis acquired in the time region for the analysis.

8. The method of an analysis according to any one of claims 1 to 7, comprising acquiring data of an ion peak as information regarding a peak area of the peak or an ion intensity thereof and an error thereof, a retention time, and m/z or m, or m and z of the peak, based on the data of the sample for the analysis.

9. The method of an analysis according to any one of claims 1 to 7, comprising acquiring data of an ion peak as information regarding a peak area of the peak or an ion intensity thereof, the presence/absence of the occurrence of a quantitative analysis-inhibitory factor, a retention time, and m/z or m, or m and z of the peak, based on the data of the sample for the analysis.

10. The method of a mass analysis according to claim 8 or 9, comprising comparing the information acquired from a plurality of the samples for the analysis.

11. An internal standard, wherein the internal standard is an internal standard used to detect a quantitative analysis-inhibitory factor in an analysis of positive ions using a liquid chromatograph/mass spectrometer, and is acidic.

12. The internal standard according to claim 11, wherein the internal standard has an isoelectric point or a dissociation constant of 8 or less.

13. The internal standard according to claim 11, wherein the internal standard has an isoelectric point or a dissociation constant of 4 or less.

14. An internal standard, wherein the internal standard is an internal standard used to detect a quantitative analysis-inhibitory factor in an analysis of negative ions using a liquid chromatograph/mass spectrometer, and is basic.

15. The internal standard according to claim 14, wherein the internal standard has an isoelectric point or a dissociation constant of 8 or more.

16. A method of an analysis using an internal standard according to claim 11 or 14.

17. A method of an analysis of a solution for the analysis containing an object substance for the analysis by using a sample preparation unit, an ionization unit, a mass-analysis unit, a control unit and a storage unit, comprising:
a step of mixing an internal standard in the solution for the analysis;
a step of introducing the solution for the analysis mixed with the internal standard to the ionization unit to produce ions;
a first step of measuring an intensity of ions originated from the internal standard by the mass-analysis unit in a condition that the internal standard is mixed in the solution for the analysis containing a constant or less concentration of the object substance for the analysis, and storing a result thereof in the storage unit;
a second step of measuring intensities of ions originated from the object substance for the analysis and the internal standard by the mass-analysis unit in a condition that the internal standard is mixed in the solution for the analysis containing an unknown concentration of the object substance for the analysis, and storing results thereof in the storage unit;
a step of calculating an inconsistency between the intensities of ions originated from the internal standard measured in the first and the second steps, and comparing the difference with a threshold of an inconsistency stored in advance in the storage unit, in the control unit;
a step of judging weather or not the difference exceeds the threshold of an inconsistency in the control unit; and
a step of changing the analysis condition of the solution for the analysis in the sample preparation unit, remeasuring the solution for the analysis containing the object substance for the analysis, and calculating a quantitative value of the object substance for the analysis, in the control unit, depending on the judgment.

18. The method of an analysis according to claim 17, wherein the internal standard comprises a first internal standard and a second internal standard, and both of an ion intensity of the first internal standard and an ion intensity of the second internal standard are used for the threshold and the judgment.

19. The method of an analysis according to claim 18, wherein the second internal standard has an isoelectric point or a dissociation constant of approximately 2 or more and 8 or less.

20. The method of an analysis of the object substance for the analysis according to claim 18, wherein by using the first internal standard as a quantitative internal standard for the quantitative value correction of a measurement value of the quantitative analysis of the object substance for the analysis, and by using the second internal standard for the threshold and the judgment, a precision in the quantitative correction by the first internal standard molecule is guaranteed.
